(19) United States
(12) Patent Application Publication
(10) Pub. No.: US 2009/0021766 A1
(43) Pub. Date: Jan. 22, 2009

(54) PRINT SYSTEM

(75) Inventor: Takeshi YAMAZAKI, Nagano (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(73) Assignee: CITIZEN HOLDINGS CO., LTD., Tokyo (JP)

(21) Appl. No.: 12/175,608

(22) Filed: Jul. 18, 2008

(30) Foreign Application Priority Data
Jul. 19, 2007 (JP) 2007-187755

(51) Int. Cl. G06K 15/00; G06F 3/12

(52) U.S. Cl. 358/1.14; 358/1.15

(57) ABSTRACT

A print system is provided that has a plurality of printer units for print processing on a print medium basis and that ejects printed materials, printed by the plurality of printer units, according to a pre-set order. Each printer unit includes peak current calculation means that analyzes a load of received print data, calculates a peak current value that will be required for printing the print data based on the load analysis, and sends the calculated peak current value, as well as a print request, to a controller. The controller compares a total current value of the peak current value, which is sent from the peak current calculation means, and a total current consumption value of printer units in print operation with a maximum current setting value stored in the print system and, based on the comparison result, controls whether or not the print request from the printer unit is permitted.

### DETAILED DESCRIPTION

1. Field of the Invention

The present invention relates to a print system that has multiple printers and ejects printed materials from the multiple printers in a predetermined ejection order.

2. Description of the Related Art

Various types of printer apparatus that has multiple printers are proposed. An example of such a printer apparatus has the configuration in which multiple printers and a common sorter are provided, the image signals are distributed to the printers, and the printers alternately generate print outputs in order of pages and eject the print outputs to the sorter in order of pages (see Patent Document 1).

In such a multi-printer to which multiple printers are connected, a predetermined printer is selected from the multiple connected printers in response to an output request and a printer job is allocated to the selected printer. In such a multi-printer, two or more of the multiple connected printers sometimes operate simultaneously and consume much power, with the possibility that the required current and power sometimes exceed the current capacity and the power capacity of the power supply line.

To solve the problem that the current consumption required by the simultaneous operation of such multiple printers exceeds the allowable current, a control device is proposed that controls the printer operation of the multiple printers to prevent the total power, consumed by the multiple connected printers, from exceeding the current capacity of the power supply system (for example, Patent Documents 2-5).

According to the technology disclosed in Patent Document 2, the print operation of a printer job that is sent is allowed only if the total power consumption of the printers in operation is equal to or lower than a setting value. This control operation prevents the total power from exceeding the current capacity of the power supply system.

According to the technology disclosed in Patent Document 3, the power consumption of each apparatus connected to a network is set in advance, and the sum of the power consumption of the apparatuses in operation and the power consumption of an apparatus that is going to start the operation is compared with the allowable capacity to prevent the total power from exceeding the current capacity of the power supply system.

According to the technology disclosed in Patent Document 4, the power consumption value allocated to a job to be executed is read from the table, and the sum of the power consumption values of the jobs executed by other image formation devices connected via the network and the allocated power consumption value is calculated. If the sum exceeds the upper limit, the jobs are processed according to job priorities. Note that the power consumption table stores the power consumption of each job execution mode as the peak value of the power consumption (paragraphs 0046 and 0064).

According to the technology disclosed in Patent Document 5, the power consumption required for the operations, such as the warm-up operation for preparing for printing and the print operation for printing, is stored in the printers. A printer on a network sends the power usage request control signal to the server before performing each operation and, in response to the request, the server sends the power usage permission control signal to the printer to prevent the total power consumption amount requested by the printers from exceeding the limitation value that is set in advance.

[Patent Document 1] Japanese Patent Laid-Open Publication No. Hei 8-305221

[Patent Document 2] Japanese Patent Laid-Open Publication No. Hei 11-143663

[Patent Document 3] Japanese Patent Laid-Open Publication No. 2002-142385

[Patent Document 4] Japanese Patent Application No. 3512016

[Patent Document 5] Japanese Patent Laid-Open Publication No. 2006-268324

To prevent the total power consumed by multiple connected printer units from exceeding the current capacity of the power supply system of a printer system having multiple printer units, the technologies disclosed in documents 2-5 described above set, in advance, the power consumption corresponding to printer apparatuses or an operation mode and, based on the power consumption of a printer which will perform the print operation, control the printers so that the total power consumption consumed in the print system does not exceed the allowable capacity.

The problem with the technologies described above is that, because the power consumption value, which is set in advance corresponding to a printer apparatus or an operation mode, is used in calculating the total power consumption of the printer unit, the calculated total power consumption sometimes does not match the power actually consumed during the print operation. The power actually consumed during the print operation depends on the print status, meaning that actually consumed power does not always match the setting value, such as a rated value, that is set in advance corresponding to the printer apparatus or the operation mode.

Although this setting value, which can be created for example by adding a margin to the base power value consumed in the usual usage status, varies according to the setting condition for determining the base value and the margin, the actual print status is not taken into consideration in setting the value. This is because, during the actual print operation, the print data amount and the printer unit operation condition vary with the print operation and, so, the power consumption varies according to the print data amount and the printer unit operation condition. Therefore, the setting value cannot be set with consideration for the actual print status.

This means that the printer control based on the power consumption which is set in advance for the printer apparatus or the operation mode, such as the control proposed in the prior art, is performed assuming a standard print operation and, based on this assumption, the printer is controlled.

Meanwhile, to prevent a system failure due to an excess current or excess power condition in a print system, it is necessary not only to control the average current value or the average power value so that it falls in the allowable range but also to control the maximum current value or the maximum power value so that it falls in the allowable range. This is because the current or the power consumed in the actual print status, which depends on the amount of print data, sometimes exceeds the rated value defined for the printer unit. Especially, when a large amount of print data is printed, the total current consumption or the total power consumption that is actually consumed sometimes exceeds the allowable amount.

In the conventional allowable value setting, increasing a margin to be added to the base current value or the base power value allows the total current consumption or the total power consumption to fall in the allowable range even if the print data amount varies, thus preventing the system from going down even when the maximum value is exceeded. In this case, however, an increased margin lowers the total current consumption or the total power consumption of a printer unit and, so, requires the whole print system to consume a longer print time.

### SUMMARY OF THE INVENTION

Therefore, it is an object of the present invention to solve the problems described above. More specifically, an object of the present invention is to control printing on a printer unit according to the print status of a print object in a print system composed of multiple printer units and thereby to allow the total current consumption or the total power consumption to fall in the allowable current range or the allowable power range of the print system.

The present invention relates to a print system having a plurality of printer units wherein a current consumption of each printer unit is calculated based on print data of each of the plurality of printer units and a combination of printer units is selected for simultaneous printing from the plurality of printer units so that a total current consumption of the calculated current consumptions is equal to or lower than a predetermined value.

The print system of the present invention calculates and predicts in advance the total current consumption, which will be consumed by the print system, based on print data. If the total current consumption exceeds the current value allowed in the print system, a combination of printer units is selected for printing from the plurality of printer units in such a way that the total current consumption during the simultaneous printing is set equal to or lower than the predetermined current so that the total current consumption is equal to or lower than the allowable current value.

The present invention relates to a print system that has a plurality of printer units for print processing on a print medium basis and that ejects printed materials, printed by the plurality of printer units, according to a pre-set order wherein, in printing a next print object, a maximum value of a total current consumption, which will be consumed by all printer units when the next print object is printed, is calculated and whether or not the printing of the next print object is permitted is controlled based on the maximum value of the total current consumption acquired from the calculation.

The maximum value of the calculated total current consumption is the maximum current value that may be reached when the total current consumption varies wherein the total current consumption is the power that will be consumed by the plurality of printer units of the print system when a print object to be printed next is printed on a printer unit.

The print system of the present invention checks if the maximum value of the total current consumption will exceed the allowable value to determine whether or not the next print object can be printed and, based on this determination, controls whether or not the printing of the print object is permitted. For example, if the total current consumption is within the allowable value, the print system determines that an excess current will not be generated and permits the printer unit to perform the print operation for printing the print object to be printed next. On the other hand, if the total current consumption exceeds the allowable value, the print system determines that an excess current will be generated and, therefore, does not permit the printer unit to perform the print operation for printing the print object to be printed next. Instead, the print system puts the print operation in the wait state until the total current consumption is changed by a change in the print status and the print object can be printed.

The configuration of the print system of the present invention described above calculates the maximum value of the total current consumption, which will be required by all printer units for printing a print object, thus allowing the print operation on the printer units to be controlled according to the print status of the print objects.

The maximum value of the total current consumption can be calculated from a total current value of a total current consumption value of printer units in print operation and a peak current value required for printing of the next print object.

The total current consumption value of the printer units in print operation is the total of the current values consumed by the printer units that are included in the plurality of the printer units in the print system and that are in print operation. The current consumption value of the printer units in print operation can be calculated, for example, based on the print data of the print object. The current consumption value calculated from the print data can be the average value required for printing one print object. This is because the print timings of the plurality of printer units do not always correspond to the same print position for the print objects and, so, the use of the average value averages the variations in the print timings.

The peak current value required for printing the next print object refers to the peak value of the current value that is required for printing the next print object to be printed on the printer unit. The value of current supplied to the head during a print operation depends on the density of the print data of the print object. That is, the higher the print data density is, the higher supplied the current value is; and the lower the print data density is, the lower the current value is. This means that, in printing one print object, the supplied current varies according to the change in the print data density and the peak current flows when the high-density part of the print data is printed with the peak current value dependent on the print data density.

So, the maximum value of the total current consumption calculated as the total of the total current consumption value of the printer units in print operation and the peak current value required for printing the next print object is the maximum value of the supply current required by the print system for printing the next print object. By controlling the printing in this method in which the maximum value of the total current consumption is set equal to or lower than the allowable value, the printing can be controlled at a higher current value on the average and, therefore, the print speed can be performed at a higher speed than the printing is controlled based simply on the rated value.

In calculating the maximum value of the total current consumption in the print system of the present invention, the maximum value can be corrected according to a temperature status. For example, if the head temperature or the print medium temperature of the printer unit is high, the amount of current required for heating the head or the print medium to a temperature required for printing can be decreased and, so, even a small amount of current ensures good print quality. In contrast, if the head temperature or the print medium temperature of the printer unit is low, the amount of current required for heating the head or the print medium to a temperature required for printing is increased and, so, a large amount of current consumption is required for maintaining good print quality.

In the present invention, the maximum value can be corrected according to the temperature status to optimize the current consumption.

The detailed configuration of the print system of the present invention is that the print system, which has a plurality of printer units that perform print processing on a print medium basis and eject the printed materials, printed by the plurality of printer units, in a pre-set order, comprises a controller that controls each of the printer units.

Each of the printer units of the print system comprises peak current calculation means that analyzes a load of received print data, calculates a peak current value that will be required for printing the print data based on the load analysis, and sends the calculated peak current value, as well as a print request, to the controller.

On the other hand, the controller compares a total current value of the peak current value, which is sent from the peak current calculation means of the printer unit, and a total current consumption value of printer units in print operation with a maximum current setting value stored in the print system and, based on the comparison result, controls whether or not the print request from the printer unit is permitted.

The total current value calculated by the controller is the total value of the current consumption consumed by the printer units that are included in the plurality of printer units and that are currently in print operation and the peak current calculated based on the analysis of the load of print data to be printed by the next print request. This total current value is the total current consumption that will be consumed to print the print object requested to be printed.

The print system checks if the total current value will exceed the maximum current setting value to determine whether or not the next print object can be printed and, based on this determination, controls whether or not the printing of the print object is permitted. For example, if the total current value is within the maximum current setting value, the print system determines that an excess current will not be generated and permits the printer unit to perform the print operation for printing the print object to be printed next. On the other hand, if the total current value exceeds the maximum current setting value, the print system determines that an excess current will be generated and, therefore, does not permit the printer unit to perform the print operation for printing the print object to be printed next. Instead, the print system puts the print operation in the wait state until the total current value is changed by a change in the print status and the print object can be printed.

The peak current calculation means provided in the printer unit corrects the peak current value, calculated from the load analysis, based on the temperature information detected by each printer unit and sends the corrected peak current value to the controller.

The detailed configuration of the peak current calculation means is that it has a correction coefficient table or a correction coefficient function that defines a relation between temperatures and correction coefficients that correct a peak current value. The peak current calculation means determines a correction coefficient for a detected temperature using the correction coefficient table or the correction coefficient function and, using the determined correction coefficient, corrects the peak current value to calculate the corrected peak current value. The head temperature or the print medium temperature can be used for the temperature information.

When the temperature of the head or the print medium of the printer unit is high, the calculated peak current value is corrected to a lower value. When the head or the print medium is in the high temperature status, the peak value of current actually flowing is lower than the peak current value acquired by the calculation. Therefore, if the calculated peak current value is directly used in controlling the printing when the head or the print medium is in the high temperature status, the printing is limited excessively. On the other hand, using the corrected peak current value allows the printing to be controlled appropriately without excessive limitations according to the temperature status of the head or the print medium.

In contrast, when the temperature of the head or the print medium of the printer unit is low, the calculated peak current value is corrected to a higher value. When the head or the print medium is in the low temperature status, the peak value of current actually flowing is higher than the peak current value acquired by the calculation. Therefore, if the calculated peak current value is directly used in controlling the printing when the head or the print medium is in the low temperature status, there is a possibility that a peak current that exceeds the calculated peak current value will flow. On the other hand, using the corrected peak current value limits the excessive peak current according to the temperature status of the head or the print medium and allows the printing to be controlled appropriately.

The controller provided in the print system of the present invention permits the print request from the printer unit and instructs the printer unit to print print-data if the comparison between the total current value and the maximum current setting value indicates that there is a sufficient amount of supply current but does not permit the print request from the printer unit and instructs the printer unit to delay in printing print data if the comparison indicates that there is not a sufficient amount of supply current.

In addition, the controller does not permit the print request from the printer unit and instructs the printer unit to recalculate a peak current value, which will be required to print at a low speed, and to send the recalculated peak current value, as well as the print request, to the controller if the comparison indicates that said print system has not a sufficient amount of supply current. In the low-speed printing, the amount of current supplied to the head is decreased and so the peak current value is decreased.

The controller calculates the total current value again using the peak current value acquired from the recalculation of the peak current value and compares the calculated total current value with the maximum current setting value again. If the re-comparison indicates that there is a sufficient amount of supply current, the controller permits the print request from the printer unit and instructs the printer unit to print print-data at a low speed. In contrast, if the re-comparison indicates that there is not a sufficient amount of supply current, the controller does not permit the print request from the printer unit and instructs the printer unit to delay in printing the print data.

The above print control is repeated and, when the print status is changed and the total current value becomes equal to or lower than the maximum current setting value, the controller permits the print request from the printer unit and allows the printer unit to perform the print processing.

The detailed configuration of the controller is that the controller has a pointer, in which control data on next processing in the print system is stored, and a monitor in which control data on a current status of each printer unit is stored.

The pointer of the present invention, in which the control data on next processing is stored, determines whether or not a print request, sent from each printer unit, is permitted based on the control data. The monitor, in which the control data on the current status is stored, monitors a processing status based on the control data for adjusting a processing timing between the printer unit and a shooter.

The pointer has a print pointer, in which control data on printing is stored, and a shoot pointer in which control data on paper ejection is stored. In the print pointer, data identifying a print object to be printed next, the maximum current setting value that indicates the maximum current allowable in the print system, and the total current consumption value that is the total of current values supplied to the printer units in operation are stored. On the other hand, in the shoot pointer, data identifying a print object to be ejected next is stored.

In response to a print request from a printer unit, the pointer compares a print object requested to be printed with the print object stored in the print pointer for determining a print order, and compares the total value of the peak current value of the print object requested to be printed and the total current consumption value with the maximum current setting value for determining whether or not the print request is permitted.

In response to a paper ejection request from a printer unit, the pointer compares a print object requested to be ejected with the print object stored in the shoot pointer for determining a paper ejection order.

The monitor of the present invention has a print monitor that relates to printing and a shoot monitor that relates to paper ejection.

The print monitor that has a data area, in which data identifying a print object in a print processing status and a current consumption value of each printer unit are stored, and a print virtual control port via which a processing timing signal is sent and received to and from the printer units.

The shoot monitor that has a data area, in which data identifying a print object in a paper ejection processing status of each printer unit is stored, and a shoot virtual control port via which a processing timing signal is sent and received to and from the shooter.

The monitor acquires a print status and a paper ejection status based on the data stored in the data areas. The monitor also updates the relation with a printer unit that sends a control signal and with the shooter based on the status of print processing and paper ejection processing. The controller of the present invention has the virtual control port in the monitor and, via this virtual control port, configures the printer units and the shooter to allow the connection to be switched easily even if the controlled printer unit or the controlled shooter is changed.

Although the total current value is compared with the maximum current setting value to control printing in the above description, the comparison may be made using not only the current but also the power.

The print system of the present invention controls printing on a printer unit according to the print status of a print object to keep the total current within the current or the power the print system can supply.

### BRIEF DESCRIPTION OF THE DRAWINGS

FIG. 1 is a diagram showing the general processing flow of a print system of the present invention.

FIG. 2 is a diagram showing the relation between a user application and a printer part in the print system of the present invention.

FIG. 3 is a diagram showing the general order control of printer units by means of a controller of the present invention.

FIG. 4 is a flowchart showing the normal print operation of the print system of the present invention.

FIG. 5 is a diagram showing an example of a print allocation order table of the present invention.

FIG. 6 is a diagram showing the relation between multiple printer units and the controller of the present invention.

FIG. 7 is a diagram showing the processing for calculating a peak current value from image data, and processing for correcting the calculated peak current value using temperature information, in the present invention.

FIG. 8 is a flowchart showing the print control procedure of the present invention.

FIG. 9 is a flowchart showing the print control procedure of the present invention.

FIG. 10 is a diagram showing an example of calculation for calculating a print load in the present invention.

FIG. 11 is a diagram showing an example of the relation between serial numbers and group numbers of the present invention.

FIG. 12 is a diagram showing the data structure in the controller of the present invention.

FIG. 13 is a diagram showing control virtual ports provided in a monitor of the present invention.

FIG. 14 is a diagram showing an example of data provided in the controller and the printer units of the present invention.

FIG. 15 is a flowchart showing the communication between the controller and the printer unit of the present invention.

FIG. 16 is a timing diagram showing the transfer of image control information between the controller and the printer unit of the present invention.

FIG. 17 is a state diagram showing the transfer of image control information between the controller and the printer unit of the present invention.

FIG. 18 is a timing diagram showing the current consumption control and the print processing between the controller and the printer unit of the present invention.

FIG. 19 is a state diagram showing the current consumption control and the print processing between the controller and the printer unit of the present invention.

FIG. 20 is a timing diagram showing the ejection of printed materials between the controller and the printer unit of the present invention.

FIG. 21 is a state diagram showing the ejection of printed materials between the controller and the printer unit of the present invention.

FIG. 22 is a timing diagram showing the ejection of printed materials to a shooter and the sorting of printed materials between the controller and the printer unit of the present invention.

FIG. 23 is a state diagram showing the ejection of printed materials to the shooter and the sorting of printed materials between the controller and the printer unit of the present invention.

FIG. 24 is a diagram showing an example of the general connection between the controller and the printer units using the I²C bus of the present invention.

FIG. 25 is a timing diagram showing the master transmission and reception of the present invention.

FIG. 26 is a diagram showing the recovery processing of the present invention for an unexpected error.

FIG. 27 is a diagram showing the recovery processing of the present invention for a medium end.

### DETAILED DESCRIPTION OF PREFERRED EMBODIMENTS

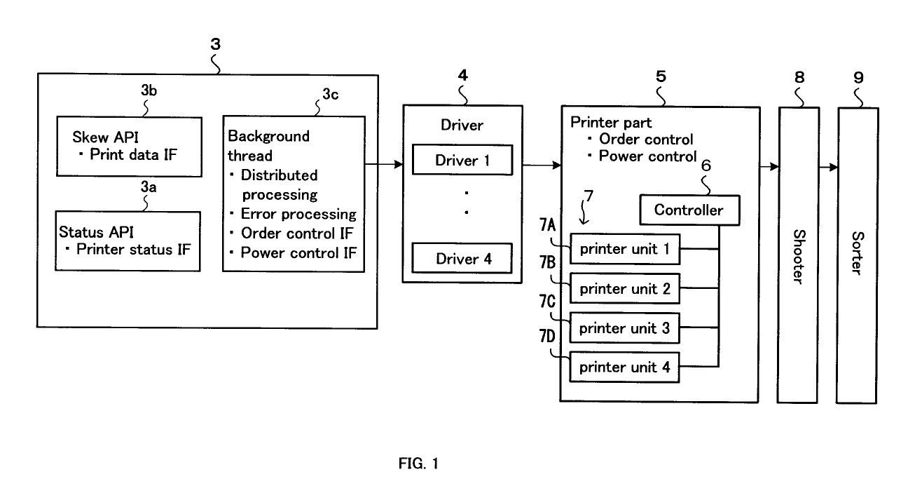

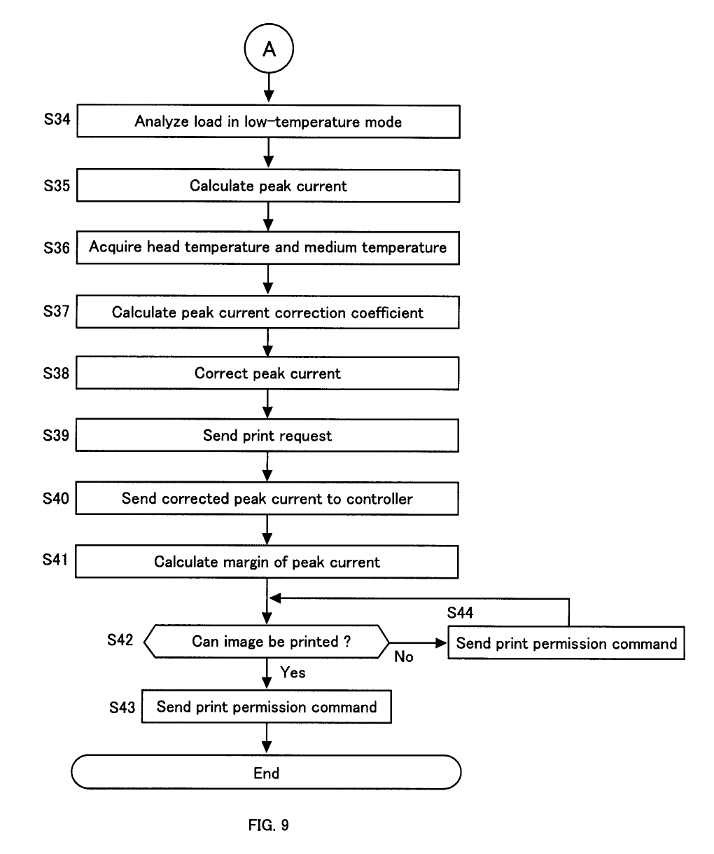

An embodiment of a print system according to the present invention will be described in detail below with reference to FIG. 1 to FIG. 25.

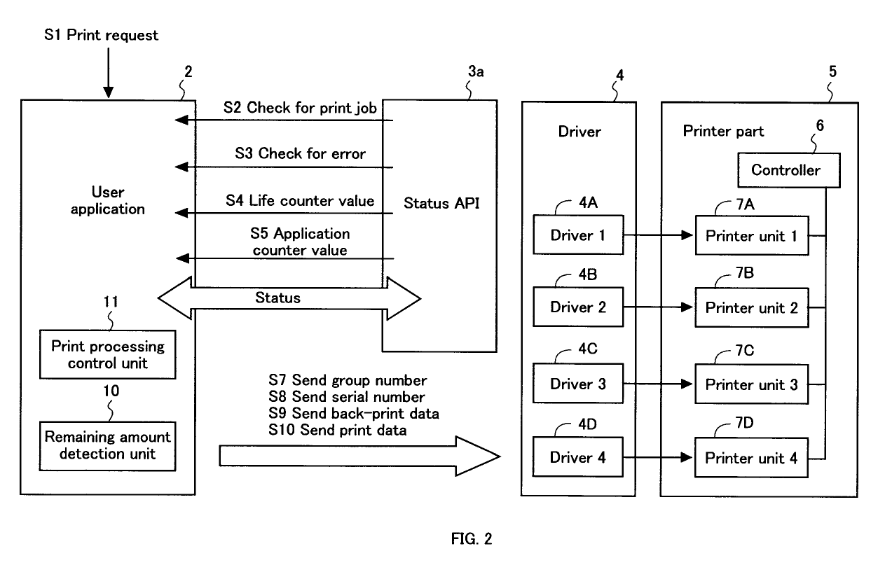

FIGS. 1 and 2 are diagrams showing the general configuration of the print system of the present invention. FIG. 1 generally shows the processing flow of the print system, and FIG. 2 shows the relation between a user application and a printer part in the print system. In FIGS. 1 and 2, only the components of a print system 1 required for the description of the present invention are shown and other components are omitted.

Although printing is controlled by the current in the description below, printing may also be controlled by the power.

Referring to FIG. 1, the print system 1 calls application program functions via an API 3. The API 3 includes a status API 3a that calls the status condition of the print system via the printer status interface(IF), a skew API 3b that calls the print data of a print object via the print data IF, and a background thread API 3c that calls a program for performing distributed processing and error processing in the background, a program for controlling the print order via the order control IF, and a program for controlling the power to be supplied to the printer units via the power control IF.

The print system 1 executes a program called via the API 3 and sends print data and commands for controlling the print processing and the paper ejection processing to a printer part 5 via a driver 4. The printer part 5, which includes multiple printer units 7 and a controller 6 that controls those printer units, prints print data, received via the driver 4, on a print medium and ejects the printed print medium to a shooter 8 in a predetermined order. The shooter 8 ejects the print medium to a sorter 9 in a predetermined order.

The printer part 5 performs the distributed processing and the error processing based on the program called via the background thread API 3c and, in addition, controls the order of printing and paper ejection and controls the power. The controller 6 of the printer part 5 controls the order of printing and paper ejection via the order control IF, and controls the power via the power control IF.

Referring to the general configuration diagram of the print system shown in FIG. 2, the print system 1 comprises the printer part 5 that prints on a print medium (not shown) to form a printed material, the user application 2 that sends print data and print processing instruction commands to the printer part 5, and the driver 4 that analyzes the commands received from the user application 2 and sends the instruction data to the driver 4. Based on the instruction from the user application 2, the printer part 5 prints on the print medium and ejects the printed matter.

The user application 2, which constitutes a print processing control unit 11, uses the status API 3a to acquire various types of status information on the printer part 5 for controlling the printing based on the acquired status information.

The user application 2, configured by hardware such as a CPU or a memory not shown, executes the control program stored in the memory and performs software processing, in which various types of processing data is stored in the primary memory, to perform the print processing control processing of the print processing control unit 11. In addition, the status API 3a can also be used by executing programs on the CPU provided in the user application 2.

The status API 3a has functions to read various types of status information on the printer units such as information on the presence and absence of print jobs, information on the presence and absence of errors, information on the amount of print data that has been printed, and information on the amount of print data that has been sent to the printers. The user application 2 can use those functions to easily acquire various types of status information on the printers.

The printer part 5 of the present invention comprises multiple printers (hereinafter called printer units) 7A-7D and the controller 6 that controls the printer units 7A-7D. The printer units 7A-7D send and receive print data and various signals via multiple drivers (hereinafter called driver units) 4A-4D included in the driver 4. The controller 6 also controls the print operation and the paper ejection operation of the printer units 7A-7D.

The printer part 5 of the present invention comprises multiple printer units 7A-7D. Although the printer part 5 comprises four printer units in the example shown in FIGS. 1 and 2, the number of printer units is not limited to four but the printer part 5 may include any number of printer units. The multiple printer units may be included in one cabinet or may be installed in separate locations.

Each printer unit 7 comprises a receiving buffer; a print data formation circuit; a page memory; a peak current calculation circuit that analyzes the load on the printer unit when print data is printed and, based on the analyzed load, calculates the peak current value that is the maximum of the current value supplied to the printer unit; and a head (Any of those components are not shown in the figure). The peak current calculation circuit may additionally comprise a circuit that temperature-corrects the peak current value based on the head temperature and the print medium temperature. This temperature correction circuit may comprise a storage unit that stores as a table or a calculation expression showing the relation between the temperature and the correction coefficients and an operation unit that corrects the peak current value, calculated based on the load analysis, using the coefficients read from the table or calculated from the calculation expression stored in the storage unit.

The peak current calculation circuit may be configured as hardware or software. In the software configuration, the peak current calculation circuit comprises a CPU and a memory, and the program that makes load analysis, the program that calculates the peak current, and the program that carries out correction calculation, all of which are stored in the memory, are executed on the CPU to perform their processing.

The receiving buffer stores print data, received from the user application 2, via the driver 4. The receiving buffer may be formed as a single-buffer configuration in which there is one buffer or a double-buffer configuration in which there are two buffers. Each receiving buffer stores print data corresponding to one sheet of print medium. In the configuration in which there are two receiving buffers, the receiving buffers can store print data for printing to form two types of print images.

Print data is stored in the receiving buffer under control of the print processing control unit 11 of the user application 2.

The print data formation circuit reads print data from the receiving buffer, expands the print data into page data, and stores the page data in the page memory.

The head sequentially reads page data from the page memory and prints the page data to form a print image on a print medium. The print medium may be any medium for printing. For example, when print data is printed as a photograph, the print medium is photographic printing paper.

The remaining amount of print medium is detected by a remaining amount detection unit 10 provided in the user application 2. To do so, the remaining amount detection unit 10 receives data on the remaining number of ink ribbons from remaining amount recording means (not shown) of each printer unit.

The remaining amount recording means is, for example, a storage device that records the remaining number of ink ribbons. When a printer unit prints an image by transferring ink from the ink ribbon to a print medium based on the print data, the remaining amount of print media can be estimated by counting the number of remaining ink ribbons because the remaining number of ink ribbons corresponds to the remaining amount of print media. For example, a configuration is possible in which an RFID is used as this storage device. An RFID is attached to an ink ribbon cassette with the number of ink ribbons at an initial time stored in the counter as the initial value. The information on the number of used ink ribbons is acquired from the printer as the RF signal, and the counter value of this counter is decremented according to the number of ink ribbons that are used. This sequence of operations records the remaining number of ink ribbons as the ID information on the RFID.

The printer acquires the remaining number of ink ribbons from this RFID. Because there is a correspondence between the remaining amount of print medium and the remaining number of ink ribbons, the remaining amount of print medium can be estimated from the remaining number of ink ribbons acquired from the RFID. An RFID makes it possible to send and receive the ID information on the number of ink ribbons that are used and the number of ink ribbons that remain unused to or from a printer through non-contact communication. So, even if the print media are exchanged, the remaining number of ink ribbons of the ink ribbon cassette and the remaining amount of print medium can be identified via the RFID, attached to the ink ribbon, by exchanging pairs of an ink ribbon cassette and a print medium between printers.

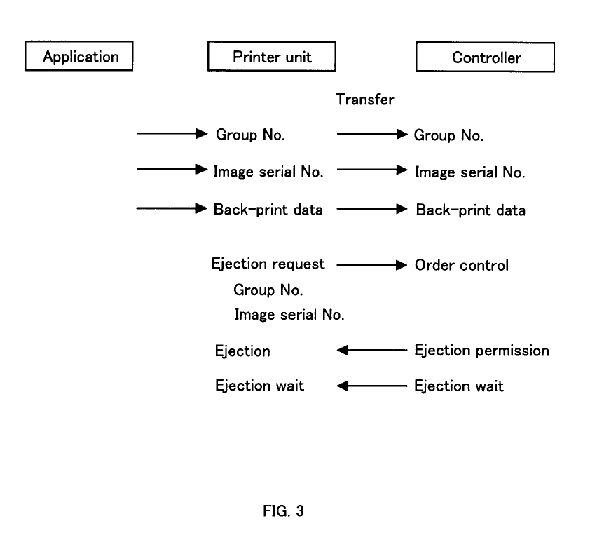

The following generally describes how the controller performs the order control of printer units with reference to FIG. 3. In the print system of the present invention, the order in which printed materials are ejected is controlled according to a predetermined order. To determine this ejection order, the application sets multiple images in the group order or in the image-serial order within each group and, according to this order, sends the group numbers and the image-serial numbers to the corresponding printer units. The printer unit 7 and the controller 6 within the printer part 5 communicate each other to control the ejection order and the paper ejection time of the printer unit.

The printer unit 7 issues an ejection request by transferring the image serial number and the group number, received from the user application 2, to the controller 6. In response to the ejection request, the controller 6 checks the order of the printed material according to the transferred image serial number and the group number. If the printed material is in the correct order, the controller 6 issues a permission to eject the printed material; if the printed material is not in the correct order, the controller 6 puts the printer unit in the wait state until other printer units finish the ejection and this printer is in the correct ejection order. This order control allows the printed materials to be ejected in order of image-serial numbers.

In one configuration of the printer unit 7, a rolled recording paper (not shown) is used as the print medium. With this rolled recording paper held in a rolled-paper holder (not shown), data is printed on the recording surface of the recording paper unrolled from the rolled-paper holder.

Printing is performed, for example, by recording ink in predetermined positions using the head with an ink ribbon (not shown), held by an ink ribbon cassette (not shown), abutting on the recording surface of the recording paper (not shown). To perform multi-color printing such as color printing during this printing, multiple ink parts, such as yellow, magenta, and cyan corresponding to the colors to be printed, are prepared on the ink ribbon sequentially along the winding direction of the ink ribbon, and the operation in which the ink part passes under the head is repeated for each color while winding the ink ribbon. At this time, the recording paper is reciprocated to overlay the colors in the same print area on the recording paper. The recording paper can be reciprocated by changing the rotational direction of the rolled paper holder to repeatedly unroll and roll the rolled paper.

This operation causes the recording paper to be reciprocated under the head 7e and repeats printing in the same print area on the recording paper multiple times.

The ink ribbon has the color parts (yellow, magenta, and cyan) as well as the overcoat layer that covers the print surface, on which all colors are printed, for protecting it.

The recording paper on which data has been printed passes under the head part and is ejected into the shooter 8. After that, the recording paper passes through the ejection path and is ejected from the ejection exit (not shown), provided on the cabinet (not shown) of the printer 1, into the sorter 9. Ejecting the papers into the shooter 8 in a predetermined order causes the printed print media to be stacked in the sorter 9 in the predetermined order for ejection.

In addition to the order control performed according to a predetermined order described above, printing and paper ejection can also be controlled in the bulk mode in which no consideration is given to the order. This bulk mode is suitable for a large amount of print jobs such as accumulated print jobs.

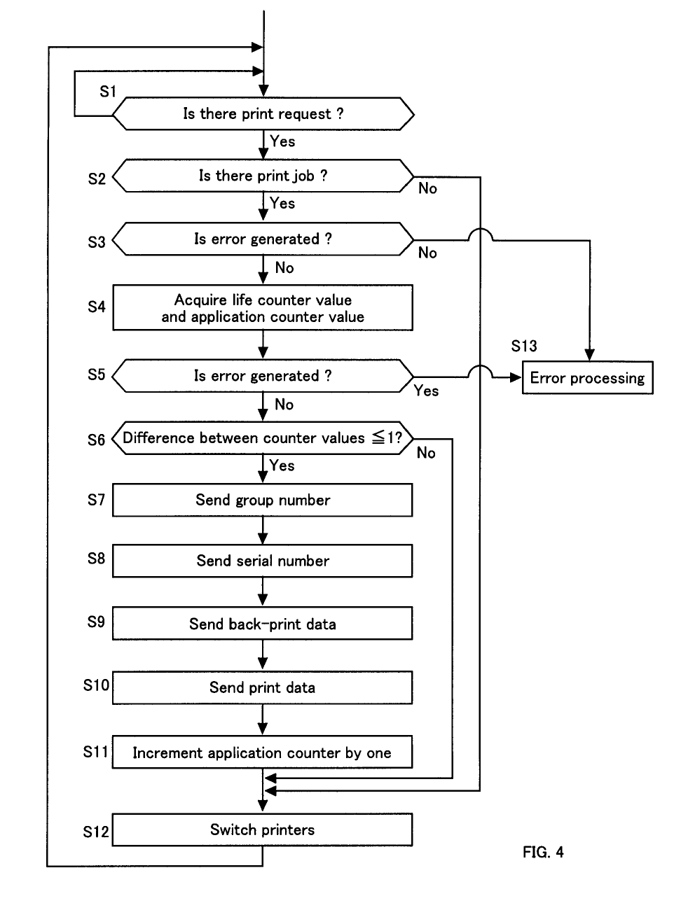

Next, the following describes the print operation of the print system of the present invention with reference to the flowchart shown in FIG. 4. The flowchart shown in the figure shows an example of the normal print operation.

First, the normal print operation of the print system of the present invention will be described based on the configuration shown in FIG. 2 and with reference to the flowchart shown in FIG. 4. A reference numeral with “S” in FIG. 2 corresponds to the corresponding reference numeral with “S” in the flowchart.

The user application 2 starts print processing based on a print request generated externally or internally (S1). If there is a print request, a check is made if a printer unit has a print job. Whether or not there is a print job can be determined by checking if the print queue in the user application contains print data for the printer unit. To determine whether or not there is print data, the program, which is read via the skew API 3b, can be used to confirm if print data is stored in the skew (not shown) (S2).

If there is no print job for the printer unit that has been checked for a print job (No in S2), the printer unit is switched to the next printer unit of the printer (S12) and control is passed back to S1 for continuing the processing.

If there is a print job for the printer unit that has been checked for a print job (Yes in S2), the program, read via the status API 3a, is used to acquire the status of the printer unit from the printer status IF to confirm if an error is generated (S3). The error condition status can be acquired by the user application that executes the corresponding function included in the status API 3a. If the acquired error status indicates that there is an error, the error processing is performed (S13).

If the acquired error status indicates that there is no error (No in S3), the user application acquires the counter value of a second counter (hereinafter called a life counter) that counts the number of print data pieces that have been printed by the printer unit. To acquire the counter value of the life counter, the user application executes the corresponding function read from the status API 3a in the background thread API 3c. In addition, the user application acquires the counter value of a first counter (hereinafter called an application counter) that counts the number of print data pieces that have been sent by the printer unit. To acquire the counter value of the application counter, the user application executes the corresponding function read from the status API 3a in the background thread API 3c (S4).

The status of the printer unit is acquired again to confirm if an error is generated (S5). If the acquired error status indicates that there is an error, the error processing is executed (S13).

In step S5, if the error status indicates that there is no error, a check is made if the printer unit has a free buffer. To check if the printer unit has a free buffer, the difference between the counter value of the life counter and the counter value of the application counter is calculated.

If the difference generated by subtracting the counter value of the life counter from the counter value of the application counter is 0 in the double-buffer configuration in which the printer unit has two receiving buffers, the number of print data pieces that have been sent is equal to the number of print data pieces that have been printed. This indicates that the print data that has been sent is all printed, meaning that the two receiving buffers are both free and so the number of free buffers is 2.

If the difference generated by subtracting the counter value of the life counter from the counter value of the application counter is 1, the number of print data pieces that have been sent is one larger than the number of print data pieces that have been printed. This indicates that the print data that has been sent is stored in one of the two receiving buffers and the other receiving buffer is free and, so, the number of free buffers is 1.

If the difference generated by subtracting the counter value of the life counter from the counter value of the application counter is 2, the number of print data pieces that have been sent is two larger than the number of print data pieces that have been printed. This indicates that the print data that has been sent is stored in both of the two receiving buffers, meaning that there is no free buffer and, so, the number of free buffers is 0.

Thus, the difference between the counter values is compared with 1. If the difference between the counter values is equal to or smaller than 1 (difference between counter values≦1), it is determined that there is a free buffer; if the difference between the counter values is larger than 1 (difference between counter values>1), it is determined that there is no free buffer (S6).

The print processing is performed if it is determined that there is a free buffer (Yes in S6). To perform the print processing, the user application 2 sends the group number of the print data that is sent, the serial number within the group, the print data to be printed on the reverse side, and the print data to the printer units 7. If the print data that is sent is the last data in the group, the information indicating that the serial number is the last serial number can be sent to confirm that all print data in the group has been sent (S7-S10).

After the sending processing in S7-S10 described above, the application counter in the user application is counted up to increment the number of print data pieces, which has been sent, by 1. The application counter can be used to confirm if there is a free buffer and, when an error occurs, to determine how much image data has been printed.

If it is determined that there is no free buffer (No in S6), the print data that will be sent can be neither stored in the receiving buffers nor printed on the printer unit. In this case, the printer unit is switched to another printer unit provided in the print 1 (S12), and control is passed back to S1.

The numeric value used to increment the life counter and the application counter is +1 when print data of the base print medium size is sent, and +2 when print that is printed on a print medium larger in the width than the base print medium size is sent. Adjusting the numeric value, used to increment the counter, to the print medium size in this way allows the remaining amount of the print medium to be confirmed correctly. To confirm if there are free buffers or if an error is generated, the difference between the counter values is set to ½ to adjust to the base print medium size for evaluation.

The application counter is initialized by acquiring the counter value of the life counter of the printer unit at system startup time and setting the acquired value in the application counter. Because the two receiving buffers are usually free in the initial state, this initialization is performed to make the counter value of the life counter in the printer unit equal to the counter value of the application counter.

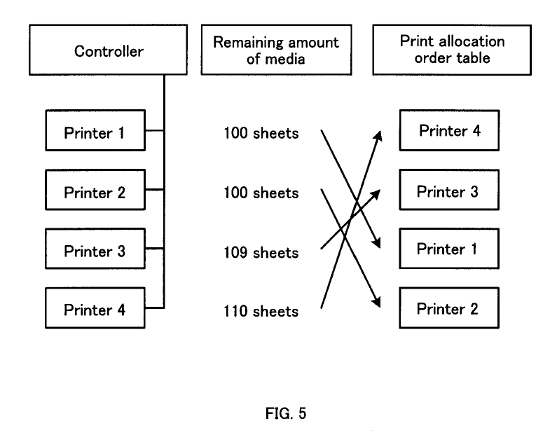

The following describes the distribution processing and the power control with reference to FIG. 5 to FIG. 10.

The distribution processing will be described with reference to FIG. 5. In a configuration where printing is performed by multiple printer units, the less frequently the print medium on the printer units is exchanged, the lighter the maintenance load of consumables becomes. So, among the printer units in the printer part, it is desirable that the amounts of used print mediums be the same and that the end of the medium be reached at the same time. However, because the number of sheets printed in one print processing operation varies in the actual operation and the time at which printing is requested differs from user to user, it is unpredictable when the power will be turned on or off on multiple printer units. If print processing is allocated to multiple printer units in a fixed order, the operation rate the printer units is increased in order of allocation, the print medium is used more frequently, and the decrease rate of print medium is increased with the result that the print medium exchange times vary among the printer units.

The print system of the present invention performs distribution processing in which print processing is allocated so that the print medium of the printer units is used evenly.

The print system, which has a print allocation order table in the user application 2, selects printer units according to the order that is set in this print allocation order table. The print allocation order table is a table in which print allocation priority is defined, and the print processing is allocated in descending order of the priority.

At the same time the application program is started, the remaining amount of the print medium in each printer unit is checked. The remaining amount is checked by the remaining amount detection unit 10. To allocate the print processing evenly, the print system of the present invention defines the priority in descending order of the remaining amounts of print medium. Because the remaining amounts of print medium vary according to the usage status, the print system checks the remaining amounts of print medium and updates the priority in descending order of the remaining amounts of print medium. The print system can dynamically create the print allocation order table to always give higher priority to a printer unit that has a larger remaining amount of print medium.

Giving higher priority to a printer unit having a larger remaining amount of print medium allows the printer units to have an approximately equal remaining amount of print medium and, as a result, to allow the print mediums to be exchanged almost at the same time.

FIG. 5 is a diagram showing an example of the print allocation order table. In the example shown in the figure, the remaining numbers of print mediums of printer unit 1 to printer unit 4 are 100, 100, 109, and 110, respectively. In this example of remaining numbers of print mediums, the printer units are arranged in the print allocation order table in descending order of remaining numbers of mediums, that is, the first priority is given to printer unit 4 and the second priority is given to printer unit 3. Because printer unit 1 and printer unit 2 both have 100 remaining mediums, the priority is given in ascending order of printer unit numbers, that is, the third and fourth priorities are given to them. As a result, the priorities are set in the print allocation order table in order of printer unit 4, printer unit 3, printer unit 1, and printer unit 2.

The next print processing is allocated according to the priorities that are set in the print allocation order table. After the print processing is terminated, the print system checks the remaining amounts of print medium again and updates the priorities in descending order of the remaining amounts of print medium.

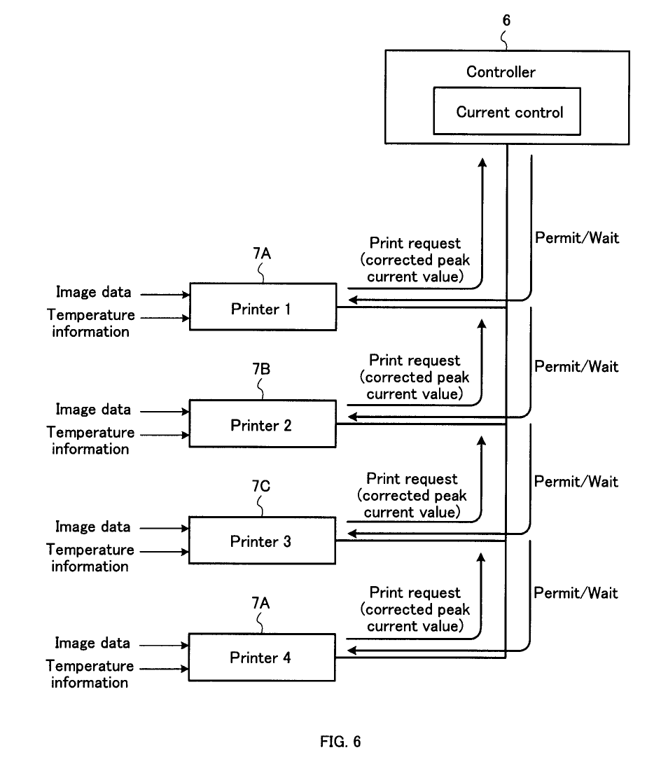

Next, the following describes how the power is controlled with reference to FIG. 6 to FIG. 10.

The print system of the present invention provides the control parameters, which specify an image pattern, temperature information, a voltage, and a current, for controlling the power.

The image pattern, which depends on the density of print data, defines the shading when a print object is printed on a print medium. In a position where the print data is at a high density, the current supplied to the head is increased to print the print data darkly. In contrast, in a position where the print data is at a low density, the current supplied to the head is decreased to print the print data lightly.

The temperature information is, for example, information on the temperature of the head or the print medium. Even if the same current is supplied to the same print data for printing, the shading of the printed data on the print medium varies according to the temperature. For example, when the temperature of the head or the print medium is high, a small current can increase the temperature high enough to print. On the other hand, when the temperature of the head or the print medium is low, a large current must be supplied to increase the temperature high enough to print.

The voltage is one of parameters for determining the power supplied by the power supply. Normally, the power supply has its power controlled by adjusting the amount of current supplied with the voltage kept constant. For example, the voltage of 100V is used in Japan, the voltage of 115V is used in the United States, and the voltage of 220V is used in Europe. So, the print system of the present invention controls the power by controlling the current and, as the control parameters for controlling the current, uses the image pattern and the temperature information to suppress the generation of an excess power that exceeds the power the power supply can supply.

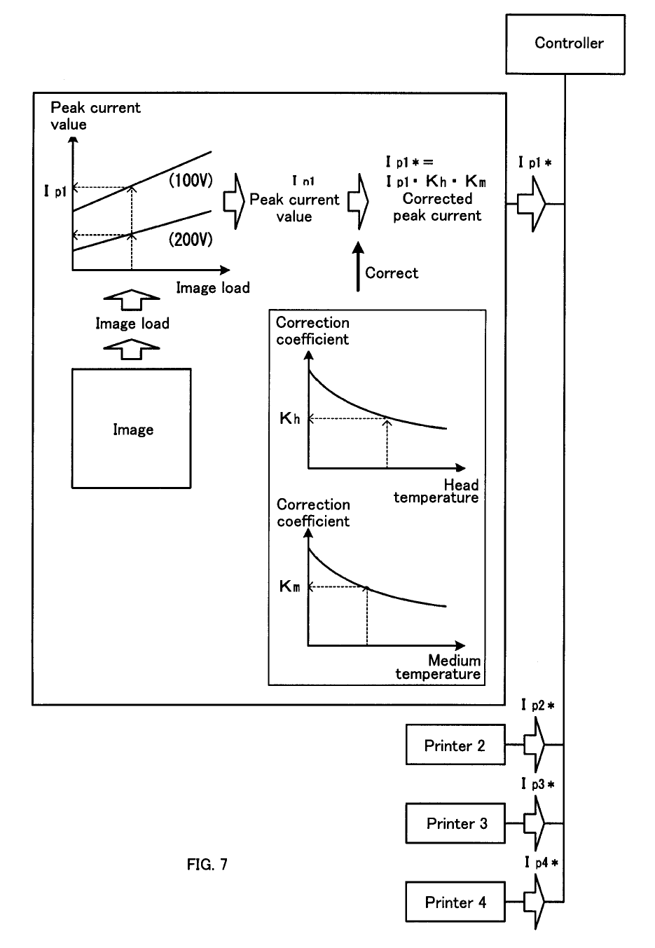

The following describes the power control configuration with reference to FIG. 6, and describes the power control by means of the control parameters (image pattern and temperature) with reference to FIG. 7 to FIG. 10.

FIG. 6 is a diagram showing the relation between multiple printer units and the controller. Referring to FIG. 6, the printer units 7 (7A-7D) each send a print request and a peak current value (corrected peak current value) to the controller 6. Based on the peak current values (corrected peak current values) received from the printer units 7, the controller 6 checks if the total current value, required by the whole print system when a print request is permitted, will exceed the maximum current value (maximum current setting value) that can be supplied by the print system power supply and, based on the checking result, determines if the print request can be permitted.

The printer unit 7 calculates the peak current value based on the image pattern. This peak current value, which refers to the value of the maximum current that flows when the print object is printed, can be calculated by analyzing the load of the image data. The controller 6 calculates the total current value using the peak current values acquired by analyzing the load of the image data, compares the calculated result with the maximum current setting value that is set in the print system and, based on the comparison result, determines if the print request can be permitted. In this way, the print system can control the printing according to the print status, not by simply using the rated currents of a printer unit, but by using the peak current value according to an image pattern that is one of control parameters.

In addition, the printer unit 7 corrects the peak current value based on the temperature information and calculates the corrected peak current value. The controller 6 calculates the total current value using the corrected peak current values, compares the calculated total current value with the maximum current setting value that is set in the print system and, based on the comparison result, determines if the print request can be permitted. In this way, the print system can control the printing according to the print status, not by simply using the rated current of a printer unit, but by using the peak current value according to an image pattern and temperature information that are control parameters.

A control instruction from the controller 6 to each printer unit 7 (7A-7D) is a response to a print request from the printer unit 7 (7A-7D). If the total current value does not exceed the maximum current setting values the controller 6 outputs a command that permits the print request because the printing can be performed within the allowable range of the power supply. In contrast, if the total current value exceeds the maximum current setting value, the controller 6 does not permit the print request and outputs a command to put the printer unit in the print wait state because the printing, if performed, exceeds the allowable range of the power supply.

This configuration, in which the image data and the temperature information are used as the control parameters for controlling the power, allows the printing to be controlled so that the total current value of the printer units does not exceed the maximum current setting value.

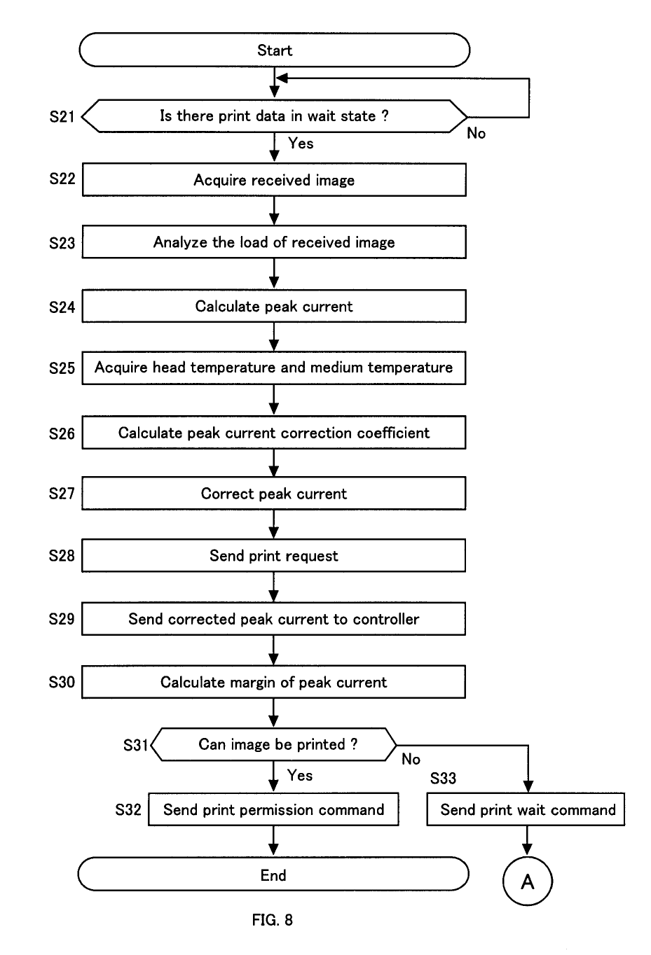

FIG. 7 is a diagram showing the processing for calculating the peak current value from image data and the processing for correcting the calculated peak current value using the temperature information. FIG. 8 is a flowchart of the procedure for controlling the printing.

If there is print data in the waiting status (S21), a printer unit receives image data to be printed on the printer unit (S22) and analyzes the load by analyzing this image data (S23). It is desirable that this load analysis be made after the image size and the colors are determined for the image data decompressed by the driver. This is because, if the image data before being transferred to the driver is used, the image data must be decompressed and, in addition, the image size is sometimes very large because the image size is not yet optimized, in which case the image processing will take long. If the power of the CPU in the printer unit is insufficient, the CPU of the PC that controls the driver may also be used.

The load analysis produces grey scale data. This grey scale data can be acquired as the grey scale values and their occurrence frequencies or the occurrence distribution. Because the positive correlation is assumed between grey scale values and supply currents, a more supply current is required for a higher grey scale value. So, the peak current that requires the largest amount of supply current for printing print data corresponds to the part of the peak grey scale. Thus, the peak grey scale value is extracted from the grey scale data to calculate the peak current value (Ipl) from this peak grey scale value and the power supply voltage. When the power supply voltage is high, the peak current value (Ipl) is low (S24).

Next, the calculated peak current value (Ipl) is corrected based on the temperature information. In this correction, the temperature of the head and the temperature of the print medium are used as the temperature information. The temperature of the head can be detected by providing a temperature sensor on, or near, the head of each printer unit, and the temperature of the print medium can be detected by providing a temperature sensor near the print medium of each printer unit (S25).

Although the temperature of the head and the temperature of the print medium are used as the temperature information in this example, one of those temperatures may be used or the temperature detected by a temperature sensor provided in other parts of the printer unit may be used.

The relation between the temperature information and the correction coefficients for correcting the peak current is established in advance and stored as a table or as a function for use in finding the correction coefficient corresponding to a temperature detected by the temperature sensor. In the description below, let Kh be the correction coefficient of the head temperature, and Km be the correction coefficient of the print medium temperature (S26).

The calculated peak current value Ipl is corrected using the correction coefficient. The corrected peak current value Ipl* can be represented, for example, as Ipl*=Ipl·Kh·Km. This correction expression is only exemplary, and a correction expression using another function may also be used. In the notation given above, the symbol * in the corrected peak current value Ipl* represents that the value has been corrected (S27).

Each of printer unit 1 to printer unit 4 sends the calculated corrected peak current value, Ipl*−Ip4*, and a print request to the controller (S28, S29). The controller calculates the total current consumption value based on the corrected peak current values IP1*−IP4* that have been received. The total current consumption value can be calculated by adding the current consumption values, consumed by the printer units in operation, to the corrected peak current values. This total current consumption value is the maximum estimated current value that will be generated when print data is printed in the next print processing. The controller compares this total current consumption value with the maximum current setting value stored in the print system to determine if there is a sufficient amount of current that can be supplied. For example, if the total current consumption value is equal to or smaller than the maximum current setting value, it is determined that there is a sufficient amount current; conversely, if the total current consumption value is larger than the maximum current setting value, it is determined that there is not a sufficient amount of current. Note that, when comparing the total current consumption value with the maximum current setting value, a bias value may be specified for the maximum current setting value to allow for a more flexible determination.

Instead of calculating the above-described peak current from the grey scale data acquired by the load analysis, each of printer unit 1 to printer unit 4 may calculate the average current from the average grey scale, calculate the current consumption of the printer unit from the average current, and calculate the total current consumption value using the calculated current consumption (S30).

If the determination described above indicates that there is a sufficient amount of current (Yes in S31), the controller 6 permits the print request (S32). If there is not a sufficient amount of current (No in S31), the controller 6 does not permit the print request and issues a “wait” command to request the printer unit to wait until another printer unit in operation finishes printing and there is a sufficient amount of current (S33).

After outputting a command requesting a printer unit to wait, it is possible to request the printer unit to recalculate the peak current value for low-speed printing. In this case, the printer unit analyzes the load in the low speed mode (S34) and calculates the peak current value (S35). In the low speed mode, printing can be performed by decreasing the current value to be supplied to the head and by setting a longer supply time.

After that, the printer unit executes the steps similar to steps as S25-S30. That is, the printer unit acquires the head temperature and the print medium temperature (S36), calculates the peak current correction coefficient (S37), and corrects the peak current value (S38). The printer unit sends a print request, as well as the corrected peak current value, to the controller (S39, S40), and the controller calculates the margin of the peak current (S41).

If the determination indicates that there is a sufficient amount of current (Yes in S42), the controller 6 permits the print request (S43). If there is not a sufficient amount of current (No in S42), the controller 6 does not permit the print request and issues a “wait” command to request the printer unit to wait until another printer unit in operation finishes printing and there is a sufficient amount of current (S44).

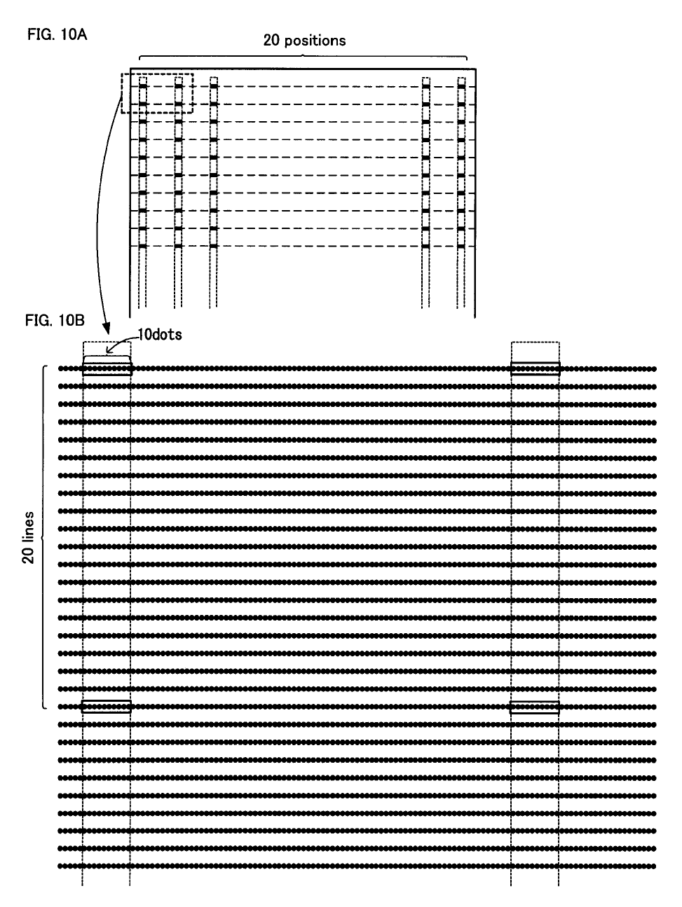

FIG. 10 is a diagram showing an example of how to calculate the load of printing. FIG. 10A shows how detected dot data is extracted to calculate the load using dot data printed on a print medium, FIG. 10B is a diagram showing the close-up of the part enclosed by the broken lines in FIG. 10A.

Referring to FIG. 10A, dots are detected in 20 positions on one horizontal line on the print medium and, in each detected position, 10 horizontally continuous dots are extracted. By this extraction, 200 dots (=20(lines)×10(dots)) of data are extracted from one line. On a line composed of 2048 dots, the dots extracted by this extraction account for about 10% (≈200/2048) of sampling rate in the horizontal direction. In the vertical direction, dots are sampled every 20th line on the print medium.

This extraction samples about 0.5% (=10%/20) of detected dots from all dots of the print data.

The load is measured by measuring the horizontal-direction load every 20th line for 10 times and by calculating the average of the data of the 2000 dots (=200(dots/line)×10(lines)) acquired from the 200 lines of the measurement range. The 200 lines of the measurement range correspond to about 16 mm in the vertical direction and to the average shading of about 0.2 seconds of printing time.

The numeric values given above are exemplary only, and the number of horizontal-direction detection positions, the number of dots extracted in one detection position, and the vertical-direction sampling rate may be determined arbitrarily.

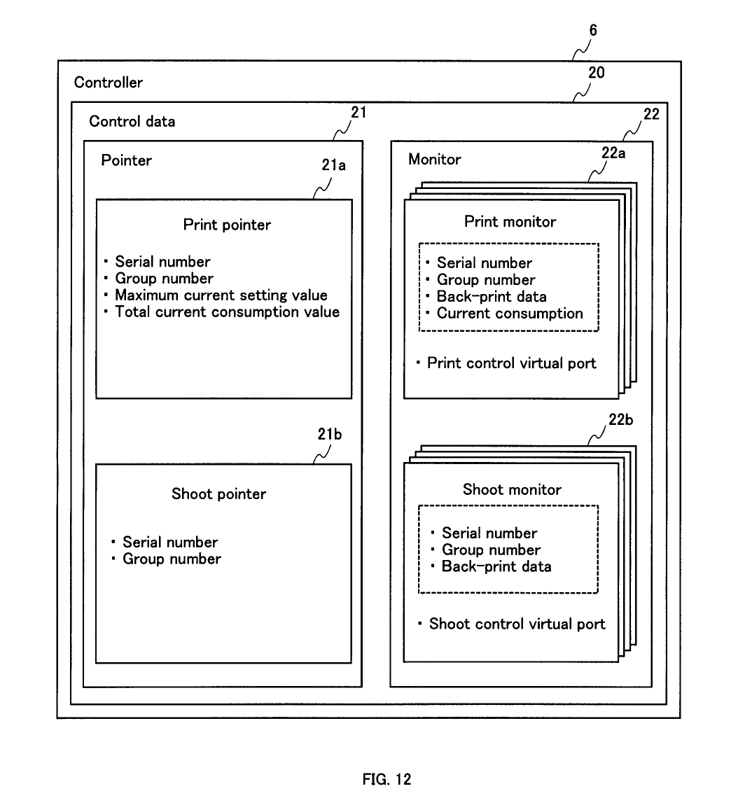

Next, the following describes the control processing performed within the controller with reference to FIG. 12 to FIG. 21.

The controller controls the print order using the control parameters. The control parameters include parameters for a serial number indicating the processing order of each image, a group number indicating the processing order and the sorting division of each image, and the back-print data (data printed on reverse side) that is printed on the reverse side of each image.

The control parameters for the serial number, the group number, and the back-print data are set in a printer unit by a special command. The printer unit processes the control parameters that are set and image data that is transferred next as a set. The last serial number has a mark indicating the end and, when this end mark is detected, the processing is performed for the next group and, at the same time, the sorting is started.

The user application sets the control parameters, that is, the serial number, the group number, and the back-print data, in a printer unit via the API of the printer unit and, thereby, specifies the processing order and the sorting division to determine the control timing. The function to automatically set the serial number and the group number may be included in the API 3 of the user application so that the serial number and the group number can be assigned.

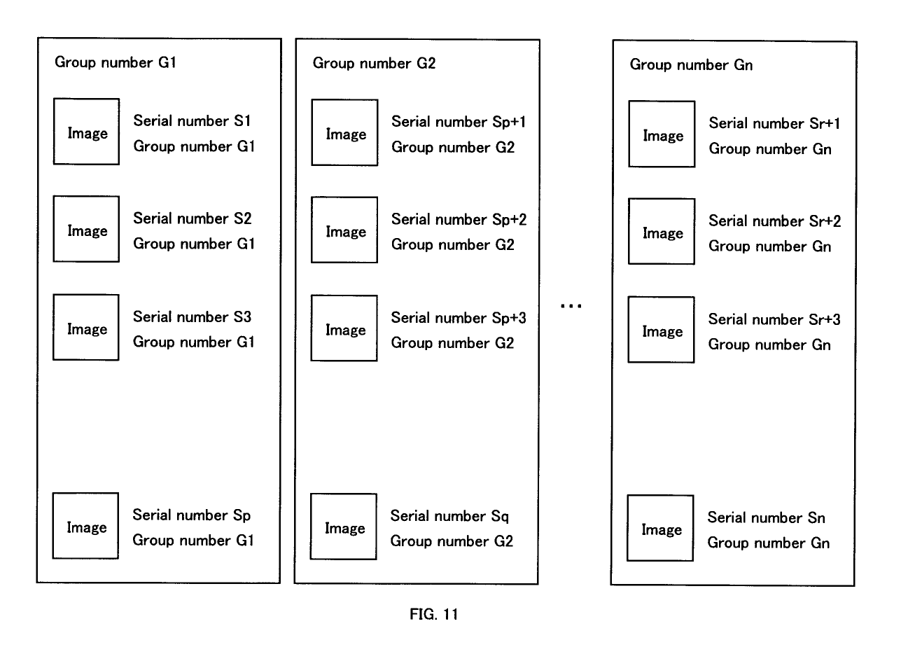

FIG. 11 is a diagram showing an example of the relation between serial numbers and group numbers. In this example, the serial numbers S1-Sp, Sp+1-Sq, . . . , and Sr+1-Sn of multiple images are divided into multiple groups with group numbers G1-Gn.

The processing order and the sorting of images can be determined based on the serial numbers, and the sorting division can be determined based on the group numbers.

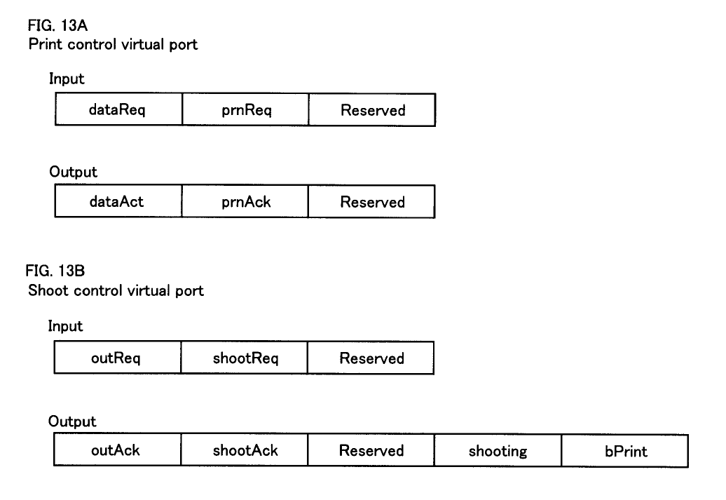

Next, the following describes the structure of data in the controller with reference to FIG. 12 and FIG. 13. Referring to FIG. 12, the controller includes control data 20 that comprises a pointer 21 indicating the next processing and a monitor 22 indicating the status of the printer units.

The pointer 21, which is control data provided in the print system, includes a print pointer 21a and a shoot pointer 21b.

The print pointer 21a has the serial number, group number, and maximum current setting value of the print object to be printed next, and the total current consumption value of the printer units that are currently printing. When a print request is issued from a printer unit, the controller 6 compares the serial number and the group number of the print object, which are sent with the print request for printing, with the serial number and the group number stored in the print pointer 21a.

If the comparison indicates a match, the controller 6 confirms that the total current consumption value does not exceed the maximum current setting value, issues a command that permits the request command, and increments the value of the print pointer 21a to update the serial number and the group number. If the total current consumption value exceeds the maximum current setting value, the controller 6 puts the printer unit operation in the wait state until another printing operation is finished and the amount of current becomes sufficient. In contrast, if the comparison indicates a mismatch, the controller 6 does not permit the print request and puts the print request in the wait state until it becomes eligible for printing.

The shoot pointer 21b has the serial number and the group number of the print object to be ejected next. When an ejection (shoot) request is issued from a printer unit, the controller 6 compares the serial number and the group number of the print object, which is sent with the ejection request for ejection, with the serial number and the group number stored in the shoot pointer 21b.

If the comparison indicates a match, the controller 6 issues a command that permits the ejection request and increments the value of the shoot pointer 21b to update the serial number and the group number. In contrast, if the comparison indicates a mismatch, the controller 6 does not permit the ejection request and puts the ejection request in the wait state until it becomes eligible for ejection.

The monitor 22, which is control data for keeping and managing the status of the printer units, includes a print monitor 22a that relates to the print status of each printer unit and a shoot monitor 22b that relates to the paper ejection status of each printer unit.

The print monitor 22a has the data, such as the serial number, the group number, the back-print data, and the current consumption value of the print object being printed by each printer unit, and the print control virtual port for communication with the printer unit for adjusting the processing timing.

FIG. 13 is a diagram showing the control virtual ports provided in the monitor. FIG. 13A shows an example of the print control virtual ports. The print control virtual port that works as an input port comprises a dataReq port that receives a data transfer request for print data, a prnReq port that receives a print request from a printer unit, and an auxiliary port. The print control virtual port that works as an output port comprises a dataAct port that outputs a transfer permission permitting a data transfer request for print data, a prnAct port that outputs a print permission permitting a print request from a printer unit, and an auxiliary port.

On the other hand, the shoot monitor 22b has the data, such as the serial number, the group number, the back-print data, of the print object being ejected by each shooter, and the shoot control virtual port for communication with the printer unit for adjusting the processing timing.

FIG. 13B shows an example of the shoot control virtual ports. The shoot control virtual port that works as an input port comprises an outReq port that receives a paper ejection start request, a shootReq port that receives a shoot start request, and an auxiliary port. The shoot control virtual port that works as an output port comprises an outAct port that outputs a paper ejection permission permitting a paper ejection request, a shootAct port that outputs a shoot permission permitting a shoot, an auxiliary port, a shooting port that outputs the status of shooting (in shooting operation), and a bPrint port that specifies a back-print.

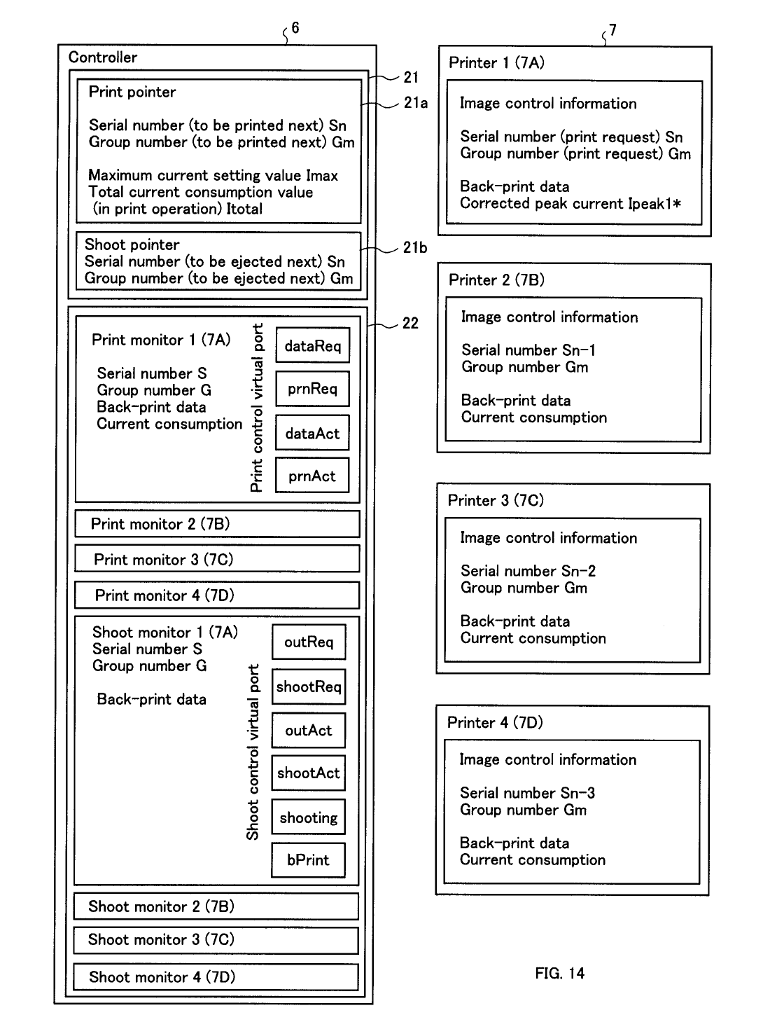

FIG. 14 is a diagram showing an example of data provided in the controller 6 and the printer units 7 (in this example, printer unit 7A—printer unit 7D).

In the example shown, printer unit 7B to printer unit 7D are printing images with the serial numbers Sn-1, Sn-2, and Sn-3, and printer unit 7A is requesting the printing of an image with the serial number Sn.

The print pointer 21a of the controller 6 contains the serial number Sn and the group number Gm of the print object to be printed next, the maximum current setting value Imax, and the total current consumption value Itotal that indicates the current consumed by the current print operation. The shoot pointer 21b contains the serial number Sn and the group number Gm of the print object to ejected next.

The print monitor 22a that monitors and manages the status of the printer unit 7A and the shoot monitor 22b that monitors and manages the shooter corresponding to the printer unit 7A indicate that neither printing nor paper ejection is being performed.

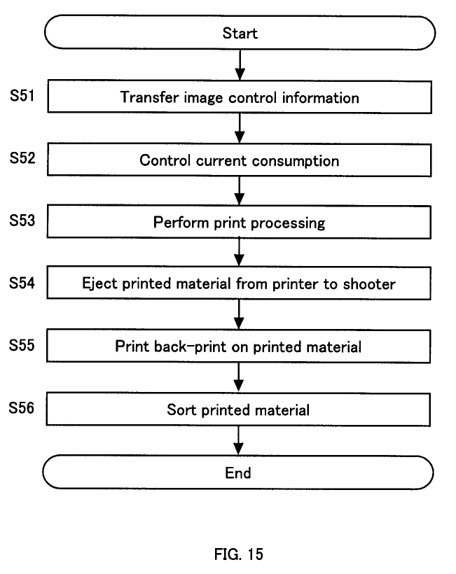

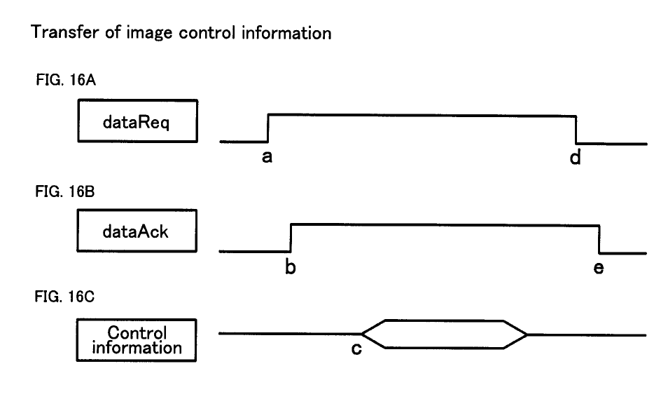

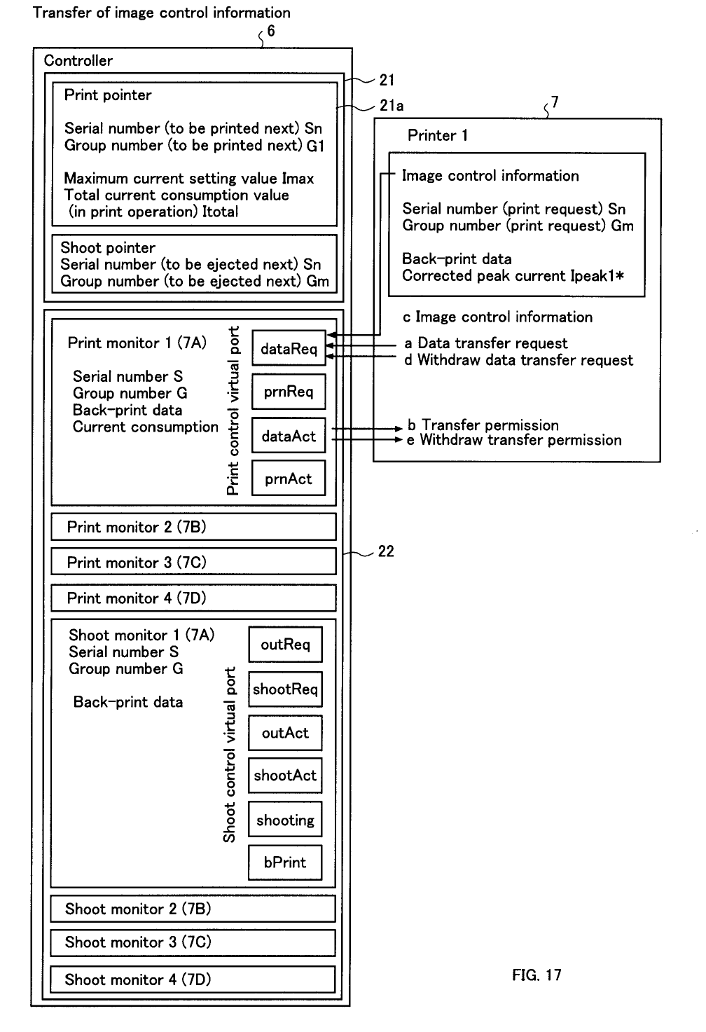

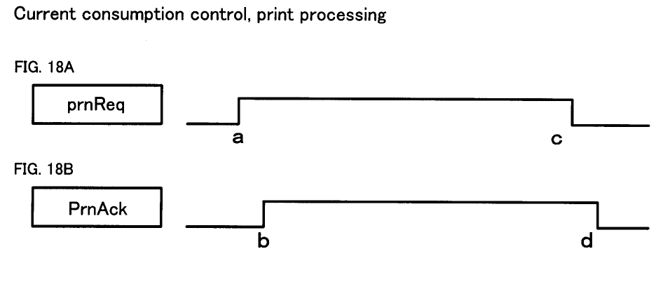

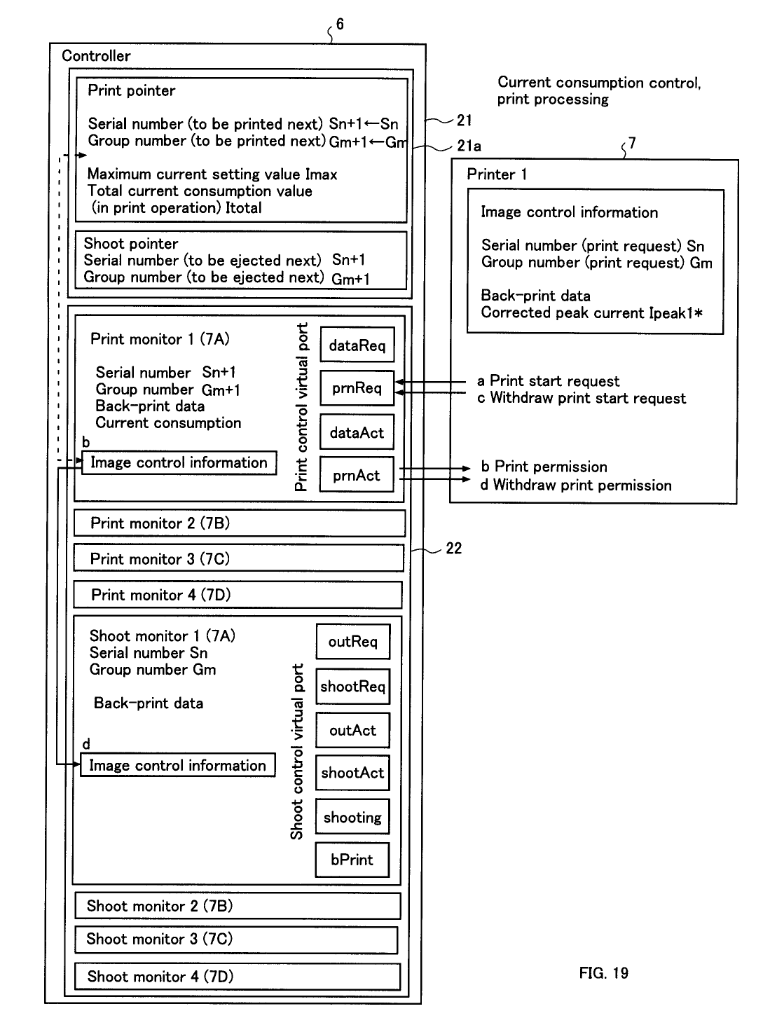

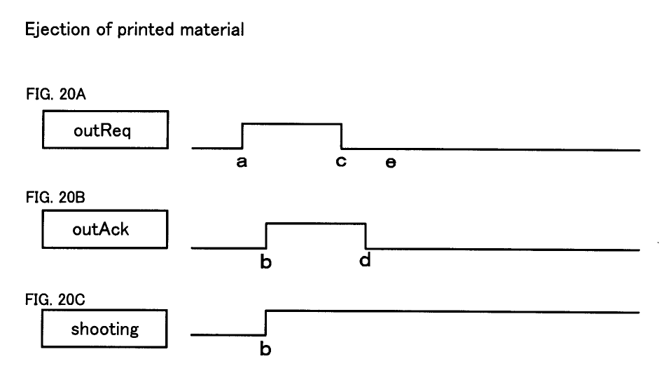

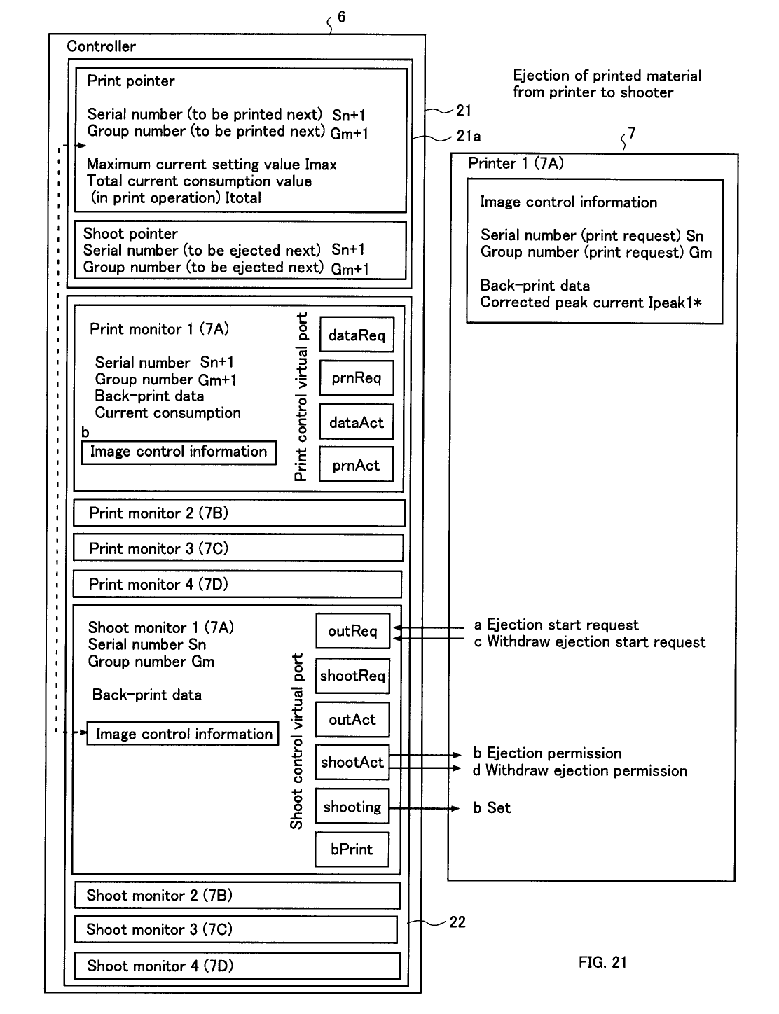

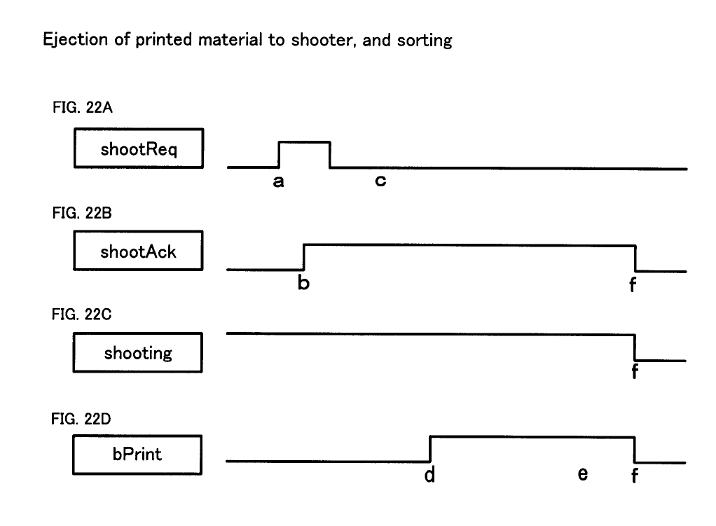

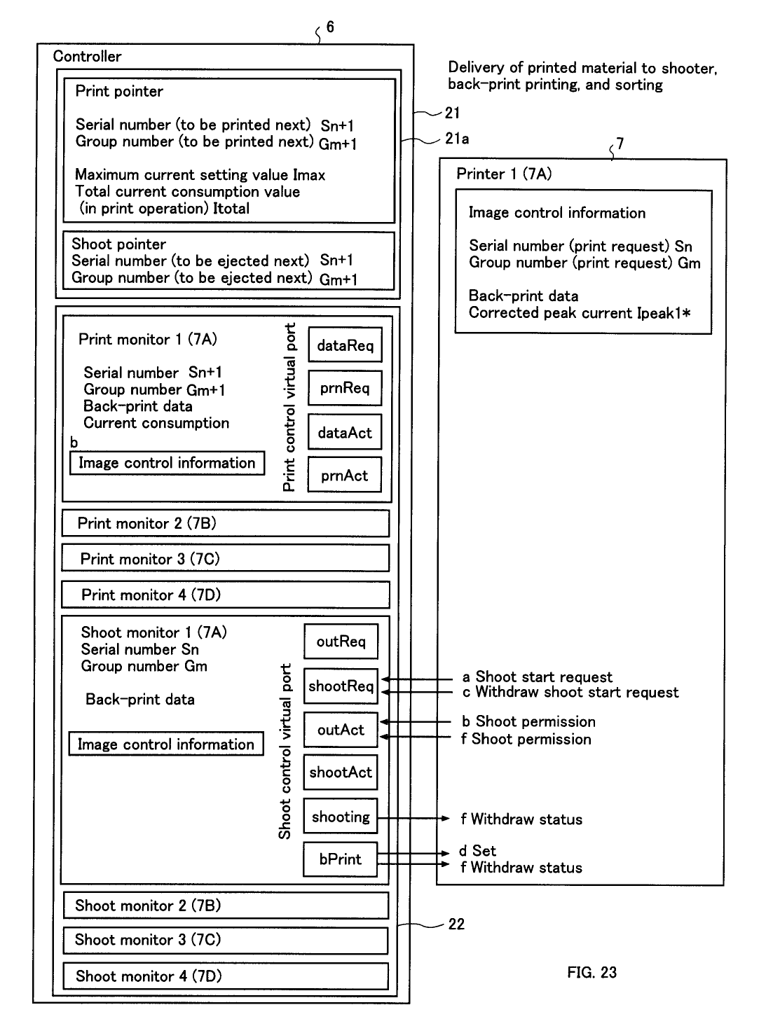

The following describes the communication between the controller and the printer units with reference to the flowchart in FIG. 15, the timing diagrams in FIG. 16, FIG. 18, FIG. 20, and FIG. 22, and the state diagrams in FIG. 17, FIG. 19, FIG. 21, and FIG. 23.

Referring to the flowchart in FIG. 15, a printer unit transfers image control information on the print object, which will be printed next, to the controller (S51). The controller controls the current consumption based on the transferred image control information (S52) and, if the print request is permitted, performs the print processing (S53). After the print processing, the printer unit ejects and passes the printed material to the shooter (S54). A back-print is printed on the printed materials transported by the shooter (S55), and the printed materials are sorted into a predetermined order (S56).

The controller and a printer unit communicate each other via the print control virtual ports, provided in the monitor 22, by adjusting (hand-shaking) the processing timing.

Out of the processing described above, the following first describes the transfer processing of the image control information with reference to FIG. 16 and FIG. 17.

When all image control information is prepared, the printer unit outputs a data transfer request to the controller via the dataReq port of the controller (a in FIG. 16A, FIG. 17). The image control information in this case includes the serial number Sn, the group number Gm, the back-print data, and the corrected peak current value Ipeak* of the print object to be printed.

When the controller becomes ready for receiving data, the controller, which has received the print request, outputs a transfer permission to the printer unit via the dataAct port (b in FIG. 16B, FIG. 17) and receives the image control information (c in FIG. 16C, FIG. 17).

After the image control information is received, the printer unit requests the controller via the dataReq port of the controller to withdraw the data transfer request (d in FIG. 16A, FIG. 17), and the controller requests the printer unit via the dataAct port to withdraw the data transfer permission (e in FIG. 16B, FIG. 17).

Next, the following describes the current consumption control and the print processing with reference to FIG. 18 and FIG. 19.

When the printer unit becomes ready for printing, it outputs a print start request to the controller via the prnReq port of the controller (a in FIG. 18A, FIG. 19). The controller, which has received the print start request, compares the serial number Sn and the group number Gm, acquired via the image control information, with the serial number Sn and the group number Gm stored in the print pointer for confirming the print order. In addition, the controller calculates the total current value by adding the total current consumption value, stored in the print pointer, to the corrected peak current Ipeak* acquired via the image control information, and compares the total current value with the maximum current setting value Imax, stored in the print pointer, for confirming the current.

After confirming the print order and the current and finding that the printing can be performed, the controller outputs a print permission to the printer unit via the prnAct port. Because the error recovery processing is sometimes performed by another printer unit, the controller outputs a print permission if the serial number and the group number are equal to or smaller than the serial number and the group number stored in the print pointer (b in FIG. 18B, FIG. 19).

After the printing is terminated, the printer unit requests the controller via the prnReq port of the controller to withdraw the print start request (c in FIG. 18A, FIG. 19). The controller requests the printer unit via the prnAct port to withdraw the print permission (d in FIG. 18B, FIG. 19).

When the print processing is performed, the controller increments the print pointer and updates the serial number Sn and the group number Gm to the serial number Sn+1 and the group number Gm+1.

Next, the following describes the processing of printed material ejection from a printer unit to the shooter with reference to FIG. 20 and FIG. 21.

When the printer unit becomes ready for paper ejection, it outputs an ejection start request to the controller via the outReq port of the controller (a in FIG. 20A, FIG. 21). In response to the ejection start request, the controller compares the serial number Sn and the group number Gm, acquired via the image control information, with the serial number Sn and the group number Gm stored in the shoot pointer for confirming the ejection order.

When the controller confirms the ejection order and finds that the printed object can be ejected, the controller causes the shooter (not shown) to eject the printed material. At the same time, the controller outputs an ejection permission to the shooter via the outAct port (b in FIG. 20B, FIG. 21), and sets the status, which indicates that the shooting is in operation, in the printer unit via the shooting port (b in FIG. 20C, FIG. 21).

At this time, because an error is sometimes generated in another printer unit, the controller outputs the ejection permission only when the serial number Sn and the group number Gm match the serial number Sn and the group number Gm stored in the shoot monitor.

When the ejection is finished, the printer unit requests the controller via the outReq port of the controller to withdraw the ejection start request (c in FIG. 20A, FIG. 21). The controller requests the printer unit via the outAct port to withdraw the ejection request (d in FIG. 20B, FIG. 21).

If the print media is a rolled paper, the printer unit cuts the rolled paper and ejects it to the shooter (e in FIG. 20A, FIG. 21).

Next, the following describes the delivery of printed materials to the shooter, the back-print print processing, and the sorting processing with reference to FIG. 22 and FIG. 23.

When the printed material can be shot, the printer unit outputs a shoot start request to the controller via the shootReq port of the controller (a in FIG. 22A, FIG. 23). In response to the shoot start request, the controller compares the serial number Sn and the group number Gm of the printed material requested to be shot with the serial number Sn and the group number Gm stored in the shoot pointer for confirming the shoot order.

The controller confirms the shoot order and, when the printed material can be shot, causes the shooter (not shown) to operate and, at the same time, outputs a shoot permission to the printer unit via the shootAct port (b in FIG. 22B, FIG. 23).

The printer unit confirms the shoot permission and, after that, withdraws the shoot start request (c in FIG. 22A, FIG. 23). The controller sets a back-print in the printer unit via the bPrint port, and starts the back-print operation (d in FIG. 22D, FIG.23). Based on the image control information stored in the shoot monitor, the controller performs the sorting processing (e in FIG. 22D, FIG. 23). After the sorting processing is completed, the controller withdraws the shoot permission and the status, which indicates that the shooting is in operation, via the shootAct port and the shooting port (f in FIG. 22B, FIG. 22C and FIG. 23).

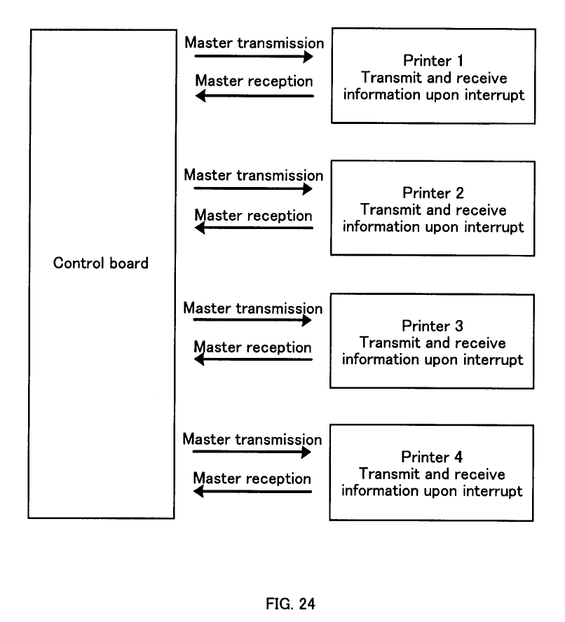

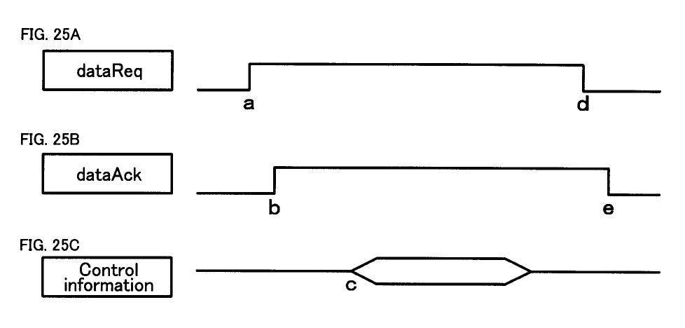

Next, the following describes an example of connection between the controller and printer units via an I²C bus with reference to FIG. 24 and FIG. 25.

The data communicated between the controller and the printer units must constantly be updated at a predetermined response time. Two types of control data are updated: one is virtual port data communicated via the virtual port that is set in the controller and the other is control data that is required to be set only once for one image such as the serial number, group information, and back-print data.

FIG. 24 is a diagram showing the relation between the control board and the printer units that communicate each other via the I²C bus. In this example, four printer units are shown.

The control board must recognize virtual port data on the four printer units. On the other hand, each printer unit is required only to recognize the virtual port data transferred to and from the control board. When the control board updates a virtual port, the control board sends one byte of information identifying the output virtual port and one-byte information identifying the input/output virtual port to each printer unit.

On the control board side, the I²C processing task transfers information sequentially with the printer units at a predetermined interval to update the virtual port information. On the other hand, an interrupt is generated in the printer unit side when information is sent from the control board and, upon detecting the interrupt, information is sent and received.

Referring to FIG. 24, the control board side transmits the information to the printer unit side in the master transmission mode. In the master transmission mode, the printer unit side generates a reception interrupt once and processes the received information when an address match occurs. The control board side receives the information from the printer unit side in the master reception mode. In the master reception mode, the control board side generates a reception interrupt when an address match occurs and recognizes the transmission request to allow the printer unit side to transmit the information. Upon receiving a transmission completion interrupt from the printer unit side, the control board side returns the mode to the slave reception mode and completes the reception and transmission.

The control data includes the serial number, the group number, and the back-print data. One-byte information is sent and received during the virtual port data communication described above while the control data communication requires the data transmission and reception of about 100 bytes. Bothe the controller and the printer unit must carry out the control data communication and the virtual port data communication separately. So, the control data communication is carried out only once immediately after the transfer handshake of image control information is established.

FIG. 25 is a timing diagram showing the master transmission and reception. As shown in FIG. 25, a printer unit sends a control data transmission request to the controller via the dataReq port of the controller side in the master reception communication mode (a in FIG. 25A).

Next, the controller allows the printer unit to transmit the control data via the dataAct port in the master transmission communication mode (b in FIG. 25B).

After the handshake is established, the controller and the printer unit communicate control data only once in the master reception communication mode (c in FIG. 25C).

Control data is transmitted within a printer unit in one of two methods. One transmission method is that the transmission interrupt processing is performed a predetermined number times (for example, 100 times) and the processing is returned to the reception last, in which case the interrupt priority is set low to allow for multiple interrupts.

The other transmission method is an event-driven method in which the flag is set during the interrupt processing and the I²C processing task transmits control data.

After the transmission of control data is completed in the control data communication mode, the transmission permission of control data is canceled (d in FIG. 25A), the transmission permission of control data is canceled (e in FIG. 25B), and the mode is returned from the control data communication mode to the virtual port communication mode.

To update the virtual port information, the function to automatically return the mode to the slave reception mode even if a communication error is generated is effective because the communication is always carried out via I²C. Because the master mode of the control board is always started in the I²C communication, the control board resets its control circuits when it detects a communication error and, after that, sets the mode to the slave reception mode and performs no processing for a predetermined time.

The I²C control task of each printer unit monitors the communication with the controller and, if no communication is performed for a predetermined time, resets its I²C control circuit and sets the mode to the slave signal mode. To monitor the communication with the controller, an I²C interrupt is generated to set the flag or the counter so that the control task can monitor the flag or the counter.

The control board communication stop period should be set sufficiently longer than the time from the moment each printer unit detects an error to the moment the I²C control circuit is reset. This long period allows the I²C communication function to be reset for restarting the communication. Not only I²C communication but also other communication algorithms such as RS422 may also be used.

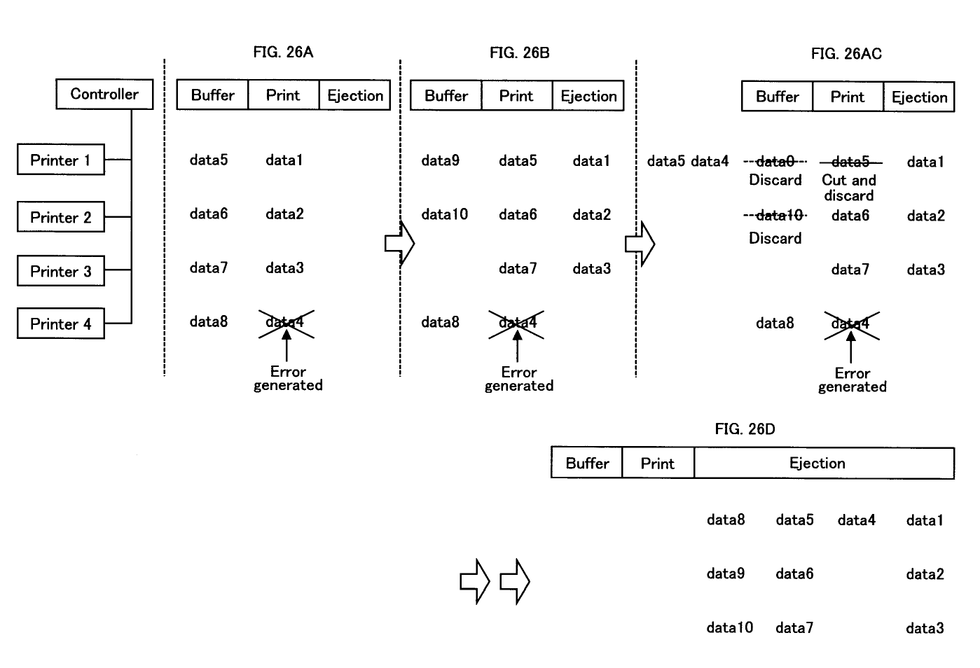

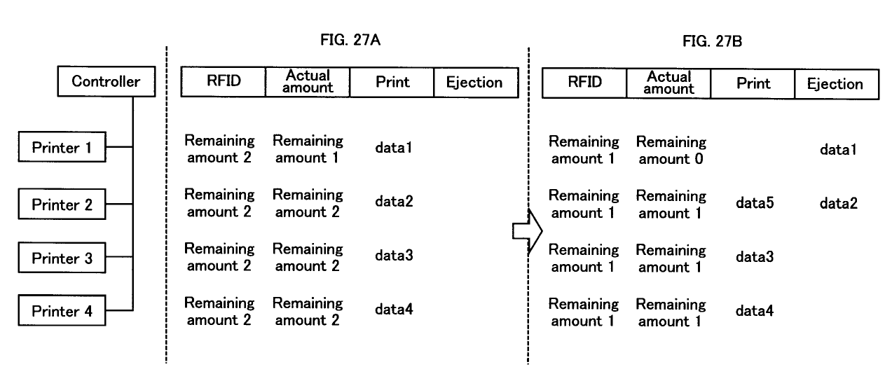

Next, the following describes the error recovery processing, which is performed when an error is generated, with reference to FIG. 26 and FIG. 27.

If an error is generated in a printer unit in the print system of the present invention where multiple printer units are connected, the recovery processing is performed to allow the printed materials to be ejected in a predetermined order. There are two types of error recovery processing: one is medium end recovery that is performed when the print medium becomes insufficient and the medium end is reached and the other is recovery processing that is performed when an unexpected error other than a medium end error is generated.

FIG. 26 is a diagram showing the recovery processing for an unexpected error. This recovery processing is performed in such a way that, when an error is generated, the normal printer units are used to maintain the correct order of printed materials and, after the correct order is established, the normal printer units are used for printing.

After the print processing of data1-data3 is finished and the printed materials are ejected, printer units 1-3 perform the print processing for data5-data7 stored in the buffers. At this time, assume that an error is detected in printer unit 4. In this case, when printer unit 1 terminates the print processing for data5 and requests the ejection of the printed material, the ejection of the printed material of data5 is not permitted but put in the wait state in order to maintain the correct ejection order (b in FIG. 26).

In this case, the printed material of data5 on printer unit 1 is cut and discarded, data9 and data10 stored in the buffers of printer units 1 and 2 are discarded, and data4 in which the error was generated and data5 that was cut and discarded are printed sequentially on printer unit 1 to maintain the order (FIG. 16C and FIG. 16D).

FIG. 27 is a diagram showing the recovery processing that is performed when the end of medium is reached. This recovery processing is performed on the printer units, other than the printer unit on which the end of medium is reached, when the occurrence of the medium end is detected.

FIG. 27 shows a case in which the end of medium is reached after printing data1 on printer unit 1 of a print system where four printer units are connected. Assume that the remaining amount of mediums of printer unit 1 is 1 and that the remaining amount of each of printer units 2-4 is 2 (FIG. 27A).

When printer unit 1 completes the printing of data1 and ejects the printed material and, at the same time, tries to prepare the next medium for printing, a medium end error is detected. The controller recognizes that printer unit 1 has completed the printing but, because the medium end is detected, does not cause printer unit 1 to perform the next printing. Instead, after recognizing that printer unit 2 has terminated the printing without an error, the controller causes printer unit 2 to print data5 (FIG. 27B).

In the example described above, the print system has a configuration in which, when a medium end error is detected, the system stops the printing on that printer unit and distributes the printing among other printer units. In addition to the configuration described above, another configuration is also possible in which two buffers are prepared in a printer unit and the next print data is stored in one of the buffers to reduce the interruption of the print processing. In this configuration, the system also predicts the occurrence of a media end and, for the printer unit on which a medium end will occur soon, performs the print processing using only one buffer to make the recovery processing easy.

To predict the occurrence of a medium end, an RF-ID having a counter, in which the remaining number of medium sheets is stored, is provided on the medium and, from this RF-ID, the remaining number of medium sheets is read to predict when the end of the medium will be reached.

The examples of the configurations described above, are exemplary only, and the present invention is not limited to those examples but includes various changes.

What is claimed is:

1. A print system having a plurality of printer units wherein
a current consumption of each printer unit is calculated based on print data of each of said plurality of printer units and
printer units, which are selected from said plurality of printer units so that a total current consumption of the calculated current consumptions is equal to or lower than a predetermined value, are combined for simultaneous printing.

2. A print system that has a plurality of printer units for print processing on a print medium basis and that ejects printed materials, printed by said plurality of printer units, according to a pre-set order wherein
in printing a next print object, a maximum value of a total current consumption, which will be consumed by all printer units when the next print object is printed, is calculated and whether or not the printing of the next print object is permitted is controlled based on the maximum value of the total current consumption acquired from the calculation.

3. The print system according to claim 1 or 2 wherein the maximum value of the total current consumption is calculated from a total current value of a total current consumption value of printer units in print operation and a peak current value required for printing of the next print object.

4. The print system according to one of claim 1 or 2 wherein the maximum value of the total current consumption is corrected according to a temperature status.

5. A print system having a plurality of printer units comprising
a controller that controls each of said printer units wherein
each of said printer units comprises
peak current calculation means that analyzes a load of received print data, calculates a peak current value that will be required for printing the print data based on the load analysis, and sends the calculated peak current value, as well as a print request, to said controller wherein
said controller
compares a total current value of the peak current value, which is sent from said peak current calculation means, and a total current consumption value of printer units in print operation with a maximum current setting value stored in said print system and, based on the comparison result, controls whether or not the print request from the printer unit is permitted.

6. The print system according to claim 5 wherein
said plurality of printer units perform print processing on a print medium basis and eject printed printed-materials according to a pre-set order.

7. The print system according to claim 5 wherein
said peak current calculation means corrects the peak current value, calculated from the load analysis, based on temperature information detected by each printer unit and sends the corrected peak current value to said controller.

8. The print system according to one of claim 5 or 7 wherein
said peak current calculation means has a correction coefficient table or a correction coefficient function that defines a relation between temperatures and correction coefficients that correct a peak current value, determines a correction coefficient for a temperature, which is indicated by the temperature information, using the correction coefficient table or the correction coefficient function, and multiplies the calculated peak current value by the determined correction coefficient for correcting the peak current value to calculate the corrected peak current value.

9. The print system according to claim 7 wherein
the temperature information is one or both of a head temperature and a print medium temperature.

10. The print system according to claim 5 or 6 wherein
said controller
permits the print request from said printer unit and allows the printer unit to print print-data if the comparison between the total current value and the maximum current setting value indicates that there is a sufficient amount of supply current but
does not permit the print request from said printer unit and causes the printer unit to delay in printing print data if the comparison indicates that there is not a sufficient amount of supply current.

11. The print system according to claim 5 or 6 wherein
said controller
permits the print request from said printer unit and allows the printer unit to print print-data if the comparison between the total current value and the maximum current setting value indicates that said print system has a sufficient amount of supply current but
does not permit the print request from said printer unit and causes the printer unit to recalculate a peak current value, which will be required to print at a low speed, and to send the recalculated peak current value, as well as the print request, to said controller if the comparison indicates that said print system has not a sufficient amount of supply current.

12. The print system according to claim 5 or 6
wherein said controller
has a pointer, in which control data on next processing in said print system is stored, and a monitor in which control data on a current status of each printer unit is stored and
wherein said pointer determines whether or not a print request sent from each printer unit is permitted based on the control data on next processing stored in said pointer and
wherein said monitor monitors a processing status, based on the control data on the current status, for adjusting a processing timing.

13. The print system according to claim 12 wherein
said pointer has
a print pointer, in which data identifying a print object to be printed next, the maximum current setting value, and the total current consumption value are stored, and a shoot pointer in which data identifying a print object to be ejected next is stored and,
in response to a print request from a printer unit,
compares a print object requested to be printed with the print object stored in said print pointer for determining a print order and
compares the total value of the peak current value of the print object requested to be printed and the total current consumption value with the maximum current setting value for determining whether or not the print request is permitted and,
in response to a paper ejection request from a printer unit,
compares a print object requested to be ejected with the print object stored in said shoot pointer for determining a paper ejection order.

14. The print system according to claim 12 wherein
said monitor has
a print monitor that has a data area, in which data identifying a print object in a print processing status and a current consumption value of each printer unit are stored, and a print virtual control port via which a processing timing signal is sent and received to and from the printer units and
a shoot monitor that has a data area, in which data identifying a print object in a paper ejection processing status of each printer unit is stored, and a shoot virtual control port via which a processing timing signal is sent and received to and from a shooter,
acquires a print status and a paper ejection status based on the data stored in the data areas, and
updates said virtual control ports based on the status of print processing and paper ejection processing.
